(19) United States
(12) Patent Application Publication
(10) Pub. No.: US 2007/0241474 A1
(43) Pub. Date: Oct. 18, 2007

(54) Process for the production of portioned packages made of water-soluble polymer film for detergent substances

(76) Inventors: Wolfgang Barthel, Langenfeld (DE); Salvatore Fileccia, Oberhausen (DE); Ulf Arno Timmann, Koln (DE); Christian Nitsch, Dusseldorf (DE); Thomas Holderbaum, Hilden (DE); Ulrich Pegelow, Dusseldorf (DE); Arno Duffels, Dusseldorf (DE); Pavel Gentschev, Monheim (DE)

Correspondence Address: PAUL & PAUL, 2000 MARKET STREET, PHILADELPHIA, PA, 19103-3229, US

(21) Appl. No.: 11/644,929

(22) Filed: Dec. 22, 2006

Related U.S. Application Data
(63) Continuation of application No. PCT/EP05/06179, filed on Jun. 9, 2005.

(30) Foreign Application Priority Data
Jun. 22, 2004 (DE) DE 102004030148.4

(51) Int. Cl. B29C 49/64; B29C 71/02

(52) U.S. Cl. 264/101; 264/345

(57) ABSTRACT

A method for producing a water-soluble or water-dispersible receptacle comprising at least one receiving chamber. Said method comprises the following steps: a) a first water-soluble or water-dispersible enveloping material is heated to a temperature T¹; b) said enveloping material is deformed so as to obtain at least one receiving chamber; c) the deformed enveloping material is cooled to a temperature T²<T¹; d) the enveloping material is deformed so as to increase the size of at least one of the receiving chambers formed in step b) and/or obtain at least one additional receiving chamber.

### CROSS-REFERENCE TO RELATED APPLICATIONS

This application is a continuation under 35 U.S.C. § 365(c) and 35 U.S.C. § 120 of International Application No. PCT/EP2005/006179, filed Jun. 9, 2005. This application also claims priority under 35 U.S.C. § 119 of German Patent Application No. DE 10 2004 030 148.4, filed Jun. 22, 2004. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention lies in the field of packaged portions for detergents or cleansing agents, such as are employed, for example, for the cleaning of textiles, tableware or hard surfaces.

Nowadays, detergent or cleansing agents are available to the consumer in a variety of commercial forms. In addition to washing powders and granulates, this range also includes, for example, detergent concentrates in the form of extruded or tableted compositions. These solid, concentrated or dense commercial forms are characterized by a reduced volume per unit of dose, and thereby lower transport and packaging costs. In particular, such detergent or cleansing agent tablets also fulfill the wish of the consumer for easy dosing. Such agents are extensively described in the prior art. Besides the cited advantages, however, compacted detergents or cleansing agents possess a number of disadvantages. In particular, products in the form of tablets, due to their high density, are often prone to a delayed disintegration and thereby a delayed release of their ingredients. To solve this “conflict” between adequate tablet hardness and short disintegration times, numerous technical solutions have been disclosed in the patent literature, wherein here, reference can be made, for example, to the use of tablet disintegrators. These disintegration accelerators are added to the tablets in addition to the active principles of the detergent and cleansing agents, and generally do not possess any properties of active detergent or cleansing agent products and, therefore, increase the complexity and the costs of the composition. A further disadvantage of tableting mixtures of active substances, particularly mixtures comprising active detergent or cleansing agent substances, is that the pressure exerted during tablet compaction can inactivate the active substances. Tableting creates much greater contact surfaces of the ingredients where chemical reactions can inactivate the active substances.

In recent years, solid or liquid detergents or cleansing agents having a water-soluble or water-dispersible packaging have been increasingly described as an alternative to the above-mentioned particulate or compacted detergents or cleansing agents. Like tablets, these compositions are characterized by a simpler dosing because they can be dosed along with the surrounding packaging into the washing machine or the automatic dishwasher, secondly, however, at the same time they also allow detergents or cleansing agents in liquid or powder form to be packaged, which in comparison with compacted forms, demonstrate a better dissolution and faster efficiency.

(2) Description of Related Art, Including Information Disclosed Under 37 C.F.R. §§ 1.97 and 1.98

Thus, European Patent No. EP 1 314 654 A2 (Unilever) discloses a dome-shaped pouch with a receiving chamber that contains a liquid.

On the other hand, pouches that contain two solids in particulate form in a receiving chamber, each solid being in fixed regions and which do not mix with each other, are the subject of Published International Application WO 01/83657 A2 (Procter & Gamble).

In addition to the packaging types that only have one receiving chamber, other product forms that include more than one receiving chamber or more than one pouch, have been disclosed in the prior art.

The subject of European Application No. EP 1 256 623 A1 (Procter & Gamble) is a kit of at least two pouches with a different composition and a different visual appearance. The pouches are separate from each other and are not present as a compact single product.

A process for manufacturing multi-chamber pouches by gluing two single chambers together is described in Published International Application WO 02/85736 A1 (Reckitt Benckiser).

The object of the present application was to provide a process for packaging detergents or cleansing agents, which allows at least two detergent or cleansing agent compositions to be packaged in a compact dosing unit in receiving chambers that are separate from one another. The appearance of the end product of the process should be appealing.

Accordingly, the object of the present invention was to provide water-soluble or water-dispersible recipients that possess a minimal empty space and are characterized by high strength and good mechanical stability under the normal conditions of production, storage and transport.

This object was achieved by a manufacturing process for water-soluble or water-dispersible recipients, in which the water-soluble or water-dispersible wrapping material of the recipient is subjected to two successive deformation steps at different wrapping material temperatures.

Accordingly, a first subject of the present application is a process for manufacturing a water-soluble or water-dispersible recipient having at least one receiving chamber, comprising the steps:

(a) Heating a first water-soluble or water-dispersible wrapping material to a temperature T¹;

(b) Deforming the wrapping material to form a receiving chamber;

(c) Cooling the shaped wrapping material to a temperature T²<T¹;

(d) Deforming the wrapping material by enlarging the receiving chamber formed in step b).

The deformation of the water-soluble or water-dispersible wrapping material at two different temperatures T¹ and T² is characterizing for the inventive process, wherein the temperature T² is below the temperature T¹. In a first step of this process, the water-soluble or water-dispersible wrapping material is, therefore, heated to a temperature T¹, i.e. a temperature above room temperature (20° C.). The wrapping material can be heated by any method known to the person skilled in the art, wherein in the context of the present application, processes are preferred, in which the water-soluble or water-dispersible wrapping material is heated in step a) by hot air, by radiated heat or by contact with a hot plate.

As mentioned, the wrapping material is heated to a temperature in step a) to temperatures above room temperature (20° C.). To guarantee an adequate deformability of the water-soluble or water-dispersible wrapping material, it is however preferred to heat the wrapping material to temperatures significantly higher than room temperature, preferably to a temperature T¹ of at least 35° C., preferably at least 40° C., preferably at least 50° C., particularly preferably at least 60° C. and especially at least 70° C.

The action of heat on the wrapping material serves to facilitate its plastic deformation. For this, the wrapping material can be heated, for example, by radiated heat, hot air or, particularly preferably by direct contact with a hot plate. Alternatively, the wrapping material can also be heated by means of heated rollers or cylinders. The duration of the heat treatment as well as the temperature of the radiated heat, hot air or the surfaces of the hot plates is naturally dependent on the type of the wrapping material that is used. A temperature T¹ between 90 and 130° C., in particular, between 105 and 115° C., is preferred for water-soluble or water-dispersible materials like PVA-containing polymers or copolymers. The duration of the heat treatment, in particular, the contact time when using a hot plate, preferably ranges between 0.1 and 7 seconds, particularly preferably between 0.2 and 6 seconds and especially between 0.3 and 4 seconds. Contact times below one second, in particular, in the range 400 to 900 milliseconds, preferably between 500 and 800 milliseconds, have proven to be particularly advantageous for polyvinyl alcohol materials.

There are various possibilities to obtain a contact between the wrapping material to be deformed and the hot plates. Thus, for example, the wrapping material can be led between two plates that are facing opposite each other, of which at least one serves as the hot plate, and the material is brought into direct contact with their surfaces by raising and/or lowering one of these plates. Alternatively, the wrapping material can also be led under or over a heated surface and be blown onto the surface by compressed air.

When hot plates are employed to heat the wrapping material, then the preferably film-forming wrapping material can be heated evenly over the complete film surface or unevenly by means of a targeted heating. In a preferred embodiment of the inventive process, the targeted heating is effected by means of hot spots located in the hot plates.

The hot spots located in the hot plates can be planar, concave or convex in shape. If the hot spots are convex or concave, then the ratio of the maximum diameter of the hot spot to its maximum height is preferably greater than 2, particularly preferably greater than 4 and particularly greater than 8.

The above described targeted heating produces a grid or lattice of non-heated and less elastic film material on the film that will be processed, which avoids an unwanted deformation and stretching of the film material in the region between the heated film parts, for example, due to its own film weight or the applied tensions during the film transport. Together the spatial orientation of the receiving basins to each other, and the spatial orientation of the receiving basins within the film, have a stabilizing effect, keeping the receiving basins in their intended positions during further transportation for filling, sealing and separation, and preventing incorrect filling, sealing or separation.

The deformation in step b) of the inventive process produces a first receiving chamber. Although in principle the inventive process is suitable for manufacturing containers of any size, the process has proved particularly advantageous for manufacturing containers with a comparatively low volume of between 1 and 60 ml, especially 2 and 50 ml, preferably 3 and 40 ml, particularly preferably 4 and 30 ml and particularly 5 and 25 ml. Independently of the total volume of the container manufactured by the inventive process, the volume of the receiving chamber formed in step b) is advantageously at least 1 ml, preferably at least 2 ml, particularly preferably at least 4 ml and particularly at least 8 ml. This first deformation of the heated wrapping material facilitates the subsequent “cold deformation” in step d) because the extent of this “cold deformation” is effected according to the type and extent of the deformation in step b).

The deformed wrapping material is cooled down to a temperature T² in step c) of the inventive process. The cooling can be effected “actively” or “passively.” A “passive” cooling can be effected, for example, by retaining the deformed wrapping material in a mold that was used in step b) at a temperature below T¹ or by transporting the deformed wrapping material on a conveyor belt at a surrounding temperature that is below a temperature T¹. The “active” cooling of the wrapping material can result, for example, by the action of cold air or cooled surfaces. In the context of the present application, particularly preferred processes are those in which the wrapping material is cooled in step c) by cold air or by contact with a cooled surface.

With regard to the strength and the mechanical stability of the final products of the inventive process, it has proved particularly advantageous when the process is controlled and held within definite preferred ranges both in regard to the temperatures T¹ and T², and to the volumes of the receiving chambers produced in process steps b) and d).

Accordingly, in the context of the present application, those processes are particularly preferred, in which the temperature T² lies at least 5° C., particularly at least 10° C., preferably at least 20° C. and especially at least 30° C. below the temperature T¹. Processes, in which the differences in the temperatures T¹ and T² lie between 5 and 90° C., particularly between 10 and 80° C., preferably between 20 and 70° C. and especially between 30 and 60° C., are particularly preferred.

In addition, preferred variants of the inventive process are those in which the ratio of the volumes of the receiving chamber volume produced in step d) to the receiving chamber volume produced in step b) is 10:1 to 1:10, particularly 7:1 to 1:5, preferably 5:1 to 1:13, particularly preferably 4:1 to 1:2 and especially 3:1 to 1:1.

The inventive process serves for the production of portioned packages of active detergent or cleansing substances. The time, at which the containers that were manufactured according to the invention are filled with these active substances, can be varied.

The inventive process can run continuously or discontinuously.

Deformation by deep drawing is particularly suitable for deforming the water-soluble wrapping material in steps b) and d) of the inventive process. Inventive processes, wherein the wrapping material is deformed in step b) and/or step d) by deep drawing, are preferred in the context of the present application.

In the context of the present application, “deep drawing” or “deep drawing processes” are those processes for fabricating packaging materials, in which said materials, after an optional pre-treatment with heat and/or solvents, are shaped by means of a suitably shaped female mold. The packaging material can be introduced as, for example, a plate or film, between both parts of the tool—the positive and the negative—and by pressing both of these parts together, can be shaped; however, the shaping can also result without the use of a negative tool, by the action of a vacuum and/or compressed air and/or the own weight of the confined materials or material combinations.

From the range of described deep drawing processes, those processes are preferred, in which the first wrapping material in the form of a film is placed above a female mold provided with cavities, and by the action of compressed air on the upper side of the film or by the action of a vacuum on the lower side of the film, particularly preferably under the simultaneous action of compressed air and a vacuum, is brought into the cavities of the female mold and shaped to correspond to the shape of the cavity. Particularly advantageous processes are those wherein the film is pre-treated by the action of heat and/or solvents prior to shaping. In a further preferred variant of the process, a film, after optional pre-treatment (solvent, heat), is pressed into the cavity of a female mold and molded by the action of a punch and/or the weight of the filling material.

The above described application of a vacuum on the inner side of the cavity of the female mold during the shaping of the film has the advantage that the air, located in the cavity below the wrapping material being molded, is easily removed and the molded wrapping material can be retained in the molded state. Continuous deep drawing processes, i.e. processes on a circulating endless female mold on which the molded receiving chambers are continuously transported for filling and/or sealing or even for cutting out, are preferred, wherein the receiving chambers formed in the cavities are held there in their molded state by means of a vacuum that is applied during the molding step and sustained until the end of the filling step, preferably to the end of the sealing step, particularly preferably to when the chambers are cut out of the film grid.

In step d) of the inventive process, the wrapping material is enlarged by enlarging the receiving chambers formed in step b). For this, the person skilled in the art can choose among a number of different procedures, of which several preferred variants will be described in more detail below:

In a preferred embodiment of the process according to the invention, the wrapping material is molded in step b) of the process in a deep drawing mold. Consequently, the volume of the formed receiving chamber essentially corresponds, i.e. to at least 94 vol. %, preferably at least 96 vol. % and especially at least 98 vol. % of the volume of the deep draw mold. In a preferred process variant, the volume of the deep draw mould is then enlarged before the wrapping material is re-molded in step d). This volume enlargement can be realized, for example, by lowering the floor of the deep draw mold or by removing the molded wrapping material from the first deep draw mold and putting it into a second, larger deep draw mold.

Accordingly, a preferred subject of the present application is a process for manufacturing a water-soluble or water-dispersible recipient having at least one receiving chamber, comprising the steps:

a) Heating a first water-soluble or water-dispersible exterior material to a temperature T¹;

b) Fitting the wrapping material into the mold of a molding tool, preferably in the mold of a deep draw female mold, to form a receiving chamber;

c) Cooling the shaped wrapping material to a temperature T²<T¹;

d) Enlarging the mold of the molding tool, preferably the mold of the deep draw female mold, by lowering the floor of the mold and/or displacing the mold walls and fitting the wrapping material into the enlarged mold to enlarge the receiving chamber formed in step b).

The depth of the mold is enlarged by lowering the floor of the mold or the walls of the mold. Processes are preferred, in which the depth of the mold, after having lowered the floor, is between 110 and 600%, preferably between 120 and 400% and especially between 130 and 200% of the original mold depth prior to lowering. In addition, those processes are preferred, in which the volume of the mold is increased by lowering the floor or by displacing the walls by 10 to 600 vol. %, preferably by 20 to 400 vol. % and especially by 30 to 200 vol. %. The absolute “stroke distance” on lowering the mold floor or on displacing the mold walls is preferably between 1 and 80 mm, particularly preferably between 2 and 60 mm and especially between 4 and 40 mm.

Moreover, those process variants are particularly preferred, in which the mold of the molding tool are provided with an elastically deformable floor or elastically deformable side walls. By using this type of mold tooling, the “lowering” of the mold floor or the displacement of the mold walls can be effected by means of an elastic deformation of the floor or the wall. For such a deformation, the whole floor or the whole wall need not necessarily be lowered; it is sufficient, rather, to partially deform the floor or the wall. Thus, originally flat floors or walls can be deformed, for example, into concave curved floors or walls.

In a further preferred embodiment of the invention, the wrapping material in step b) of the inventive process is fitted into a deep draw mold, wherein the resulting receiving chamber does not completely fill up the deep draw mold however. Preferably, the volume of the formed receiving chamber is significantly less than the previously cited 94 vol. % of the deep draw mold. Process variants are preferred, in which the volume of the receiving chamber formed in step b), corresponds to less than 90 vol. %, preferably less than 80 vol. %, preferably less than 70 vol. % and especially between 30 and 60 vol. % of the deep draw mold. After the wrapping material has been cooled down in step c), it is then deformed again in the subsequent step d), wherein the deep draw mold in this second deformation step enlarges the receiving chamber formed in step b), and the deep draw mold is filled to a greater extent.

These types of process variants can be realized, for example, by choosing that the molding forces acting on the wrapping material in step d) are greater than those forces acting in step b). This can be by raising, for example, the reduced pressure acting on the wrapping material or augmenting the impinging compressed air, the effective stamping force or the effective weight. In a particularly preferred process variant, different actions are employed on the wrapping material in steps b) and d), for example, compressed air and vacuum or by the use of a punch and a vacuum. In a quite particularly preferred embodiment, the wrapping material in step b) is fitted by the action of compressed air or by the action of a punch, whereas in step d) it is fitted by the action of a vacuum.

Accordingly, a further preferred subject of the present application is a process for manufacturing a water-soluble or water-dispersible recipient having at least one receiving chamber, comprising the steps:

a) Heating a first water-soluble or water-dispersible exterior material to a temperature T¹;

b) Molding the wrapping material by the action of a punch or compressed air to form a receiving chamber.

c) Cooling the shaped wrapping material to a temperature T²<T¹;

d) Deforming the wrapping material by the action of a vacuum to enlarge the receiving chamber formed in step b).

In a further preferred variant of the process, the heated wrapping material in a first molding step is fitted into the mold of a deep draw female mold by the action of a vacuum. By lifting or reducing the vacuum, the forces acting on the wrapping material are reduced prior to or at the same time as the wrapping material is cooled, whereby the volume of the receiving chamber diminishes due to the resulting recovery forces The wrapping material is again deformed in step d) by reapplying a vacuum after the end of the cooling.

The receiving chambers formed by deep drawing can have any shape that is technically possible. Spherically dome shaped, cylindrical or cubic chambers are particularly preferred. Preferred receiving chambers have at least one edge and one corner. Receiving chambers with two, three, four, five, six, seven, eight, nine, ten, eleven, twelve, thirteen, fourteen, fifteen, sixteen, seventeen, eighteen, nineteen, twenty or more edges or two, three, four, five, six, seven, eight, nine, ten, eleven, twelve, thirteen, fourteen, fifteen, sixteen, seventeen, eighteen, nineteen, twenty or more corners are also feasible and inventively preferred. Further feasible and preferred receiving chambers in alternative embodiments of the inventive process have a dome-shaped design. The side walls of the receiving chambers are preferably planar. Side walls that are spatially opposite one another can be both parallel and also not parallel to one another. The base of the receiving chambers can be convex, concave or planar, planar bases being preferred. The base itself can be circular, but can also have corners. Bases with one corner (droplet form), two, three, four, five, six, seven, eight, nine, ten, eleven, twelve, thirteen, fourteen, fifteen, sixteen, seventeen, eighteen, nineteen, twenty or more corners are also preferred in the context of the present application. In preferred embodiments of this application, the transition of the base to the side wall(s) or the transition of the side walls into one another is in a well-rounded shape. Consequently, the receiving chambers do not possess any exterior spikes or sharp edges but rather rounded edges.

Accordingly, a preferred inventive process is one wherein the bases of the receiving chambers are planar.

In a particularly preferred embodiment of the process according to the invention, the receiving chamber formed in step b) is filled before, during or after the cooling.

Accordingly, a preferred subject of the present application is a process for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the molded wrapping material down to a temperature T²<T¹, wherein the receiving chamber formed in step b) is filled before, during or after the cooling.

d) Deforming the wrapping material by enlarging at least one receiving chamber formed in step b).

In a further preferred embodiment, the receiving chamber is filled following the molding of the wrapping material in step d). Inventive processes, wherein the wrapping material enlarged in step d) is filled, are particularly preferred in the context of the present application.

Accordingly, a preferred subject of the present application is a process for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the shaped wrapping material to a temperature T²<T¹;

d) Deforming the wrapping material by enlarging the receiving chamber formed in step b) and filling the enlarged receiving chamber.

Of course, the receiving chambers can also be filled following both steps b) and d). Inventive process for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the molded wrapping material down to a temperature T²<T¹, wherein the receiving chamber formed in step b) is filled before, during or after the cooling.

d) Deforming the wrapping material by enlarging the receiving chamber formed in step b) and filling the enlarged receiving chamber.

The active substances or mixtures of active substances can be filled in solid or liquid form into the receiving chambers.

If the receiving chambers are filled with active substances in both steps b) and d), then these agents can of course differ in their composition and/or in their state of aggregation. In the following, the state of aggregation of the fillable active substances will be differentiated between solid and liquid agents, wherein in the context of the present application, active substances are considered to be solids when they have a solid, i.e. shape stable, non-flowable consistency. Substances, for example, in the solid state, but also shape stable substances such as gels or combinations of these substances fall into this category. Moreover, filler bodies having a solid outer casing are designated as solids, i.e. independently of the state of aggregation of the fillers comprised in these filled bodies. Examples of this type of filled body are liquid-filled gelatin capsules, for example.

In the context of the present application, powders and/or granules and/or extrudates and/or compactates and/or castings are preferably considered as solids, i.e. independently of whether they are pure substances or mixtures of substances. The cited solids can be present in amorphous and/or crystalline and/or partially crystalline form. In the context of the present invention, preferred solids have a water content (measurable, for example, as the loss in drying or according to Karl Fischer) below 7 wt. %, preferably below 4.5 wt. % and particularly preferably below 2 wt. %.

Powder is a general term for a form of divided solid materials and/or mixtures of materials that are obtained by comminution, i.e. pulverizing or crushing in the mortar (pulverizing), grinding in mills or as the result of spray drying or lyophilization. A particularly fine dispersion is often called atomizing or micronizing; the corresponding powders are called micro-powder. Preferred powders have a uniform (homogeneous) mixture of the solid, finely divided components and in the case of mixtures of substances, do not tend to separate into the individual components of the mixture. Accordingly, in the context of the present application, particularly preferred powders have a particle size distribution, in which at least 80 wt. %, preferably at least 60 wt. %, particularly preferably at least 95 wt. % and especially at least 99 wt. % of the powder, each based on the total weight, diverge to maximum 80%, preferably maximum 60% and especially maximum 40% from the average particle size of this powder.

Powder is normally broadly classified according to its particle size into coarse, fine and very fine powder; a more accurate classification of bulk powders is made on the basis of bulk density and by sieve analysis. In principle, powders of any particle size can be used, however, preferred powders have average particle sizes of 40 to 500 μm, preferably 60 to 400 μm and especially 100 to 300 μm. Methods for determining the average particle size usually depend on the above-mentioned sieve analysis and are extensively described in the prior art.

Unwanted agglomeration of the powders can be countered by the use of flow aids or dusting agents. In a preferred embodiment, the powders manufactured according to the inventive process, therefore, comprise flow aids or dusting agents, preferably in parts by weight of 0.1 to 4 wt. %, particularly preferably 0.2 to 3 wt. % and especially 0.3 to 2 wt. %, each based on the total weight of the powder. Preferred flow aids or dusting agents are, preferably in very finely ground form, silicates and/or silicon dioxide and/or urea.

As particulate mixtures, powders can be agglomerated by a series of techniques. Any known method in the prior art is basically suitable for the agglomeration of particulate mixtures to convert the solids included in the inventively manufactured containers into larger aggregates. As solid(s) in the context of the present invention, preferred added agglomerates are, besides the granules, the compactates and extrudates.

Aggregations of granule particles are designated as granulates. A granule grain (granulate) is an asymmetric aggregate of powder particles. Granulation methods are extensively described in the prior art. Granules can be manufactured by wet granulation, by dry granulation or compaction and by granulation of solidified melts.

The commonest granulation technique is wet granulation as this technique is subject to the fewest limitations and is the most reliable for producing granules with favorable properties. Wet granulation is effected by moistening the powder mixture with solvents and/or mixtures of solvents and/or solutions of binders and/or solutions of adhesives and is preferably carried out in mixers, fluid beds or spray towers, wherein the cited mixers can be equipped, for example, with stirrers and kneading tools. However, combinations of fluid bed(s) and mixer(s) or combinations of various mixers can also be used for the granulation. Depending on the starting material and the desired product properties, the granulation is effected under the action of low to high shear forces.

When the granulation is effected in a spray tower, then melts (melt solidification) or preferably aqueous slurries (spray drying) of solid substances can be used as the starting materials, which are sprayed at the top of a tower in defined droplet sizes, solidify or are dried in free fall and accumulate on the floor of the tower as the granulate. In general, melt solidification is particularly suitable for shaping low melting materials that are stable in the region of their melting point (e.g., urea, ammonium nitrate and various formulations like enzyme concentrates, medicaments etc.); the corresponding granulates are also called prills. Spray drying is particularly employed for manufacturing detergents or detergent ingredients.

Additional agglomeration techniques that are described in the prior art are the extruder or piercing mill granulation, in which powder mixtures, optionally mixed with granulation liquid, are plastically shaped by molding though a die plate (extrusion) or on piercing mills. The products from extruder granulation are also called extrudates.

Compactates can be manufactured by means of dry granulation methods such as tableting or roller compaction. Single or multiphase tablets or briquettes can be manufactured by compacting in tablet presses. In addition to multi-layer or sandwich tablets, multi-phase tablets also include coated tablets and bull's eye tablets. Briquettes, like shells that are manufactured in compaction rollers, can be comminuted at the end of the compaction by means of counter rotating pin feed drums or be struck through sieves.

In the context of the present application, castings are solid particles that are manufactured by solidification and/or crystallization of melts or solutions. Preferably, the solidification and/or crystallization takes place in pre-prepared female molds. The castings, ejected from the female mold after solidification, can then, depending on the size of the mold and the end-use of the casting, be used in their original size or optionally after comminution, as the solid.

In a particularly preferred embodiment of the process according to the invention, the receiving chamber is filled up with different solids in steps b) and d). Preferably, the solids used for filling in the steps b) and d) differ, particularly in regard to the type and/or amount of colorant comprised in them.

Depending on the chemical composition or the nature of the filled active substances or mixture of active substances, it can be advantageous to seal the filled chambers. Accordingly, inventive processes, wherein the filled receiving chamber is sealed, are particularly preferred in the context of the present application.

The sealing of the receiving chamber and the adhesive bond of the wrapping material of the receiving chamber with the sealing material are produced preferably by the action of pressure and/or heat and/or solvent. Water-soluble or water-dispersible materials, preferably water-soluble or water-dispersible polymers, are preferred sealing materials. The sealing material used for sealing can be identical to the wrapping material employed in step a) of the inventive process, but can also differ in its composition or thickness.

In a preferred embodiment of the process according to the invention, the surface of the wrapping material and/or the sealing material is first etched with a solvent before sealing (in the case of water-soluble films, water is particularly suitable) and then sealed by the action of pressure and/or heat. Suitable sealing temperatures for water-soluble wrapping materials are e.g., 120 to 200° C., preferably temperatures in the range 130 to 170° C., particularly temperatures in the range 140 to 150° C. Pressures in the range 250 to 800 kPa, preferably 272 to 554 kPa, particularly preferably 341 to 481 kPa have proved to be advantageous sealing pressures. The sealing times preferably range from at least 0.3 seconds, preferably between 0.4 and 4 seconds. Sealing temperatures, pressures and sealing times also depend on the sealing machine in addition to the wrapping material. In a preferred inventive process, the width of the sealing seams is between 0.5 and 7 mm, preferably between 1.0 and 6 mm and particularly between 1.5 and 5 mm. Sealing seam widths greater than 2 mm, preferably more than 2.5 mm, particularly preferably greater than 3 mm and especially greater than 3.5 mm have proven to be sufficiently stable. As the width of the sealing seam, depending on the production, can also vary for a single package, the cited data for the width of the sealing seam are for the minimal seam width measured on a single package. Sealing is carried out especially when the filling material is a liquid or is flowable. Examples of filler materials of this type are liquids, gels or particulate solids like powders.

By sealing the receiving chambers, not only a contact between the filled active principle or mixture of active principles or the surrounding atmosphere (e.g., atmospheric oxygen, air humidity) or a skin contact with the consumer is avoided, but at the same time the sealing also enables the release of the active principles located inside the sealed cavity to be controlled by the choice of suitable sealing materials. An example of such control is the use of water-soluble or water-dispersible sealing and/or wrapping materials of different solubilities, with the aim of releasing the contents of individual receiving chambers into the surrounding aqueous medium in a defined order. Thus, in the context of the present application, processes can be implemented, in which the wrapping material as well as the sealing material used for sealing the receiving chambers are made of the same or different materials. In a preferred embodiment, the wrapping material and the sealing material are identical in their composition. This embodiment enables the fillers located under the sealed surfaces to be released at the same time. In a further preferred embodiment, the materials used for sealing the receiving chambers are different.

In a preferred embodiment of the inventive process, the receiving chamber is sealed before the reshaping of the wrapping material in step d). Inventive processes for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the molded wrapping material down to a temperature T²<T¹, wherein the receiving chamber formed in step b) is filled before, during or after the cooling and then, on completion of the filling, is sealed.

d) Deforming the wrapping material by enlarging the receiving chamber formed in step b) and filling the enlarged receiving chamber;

are particularly preferred in the context of the present application.

In particular, those inventive processes for manufacturing a water-soluble or water-dispersible recipient having at least one receiving chamber are particularly preferred, comprising the steps:

a) Heating a first water-soluble or water-dispersible exterior material to a temperature T¹;

b) Shaping the wrapping material to form a receiving chamber by deep drawing the wrapping material in a deep drawing mold;

c) Cooling the molded wrapping material down to a temperature T²<T¹, wherein the receiving chamber formed in step b) is filled with a solid before, during or after the cooling and then, on completion of the filling, is sealed.

d) Deforming the wrapping material by enlarging the receiving chamber formed in step b), preferably by lowering the floor of the deep drawing mold of step b), and filling the enlarged receiving chamber with a liquid;

are particularly preferred in the context of the present application.

In a further preferred embodiment of the inventive process, the receiving chamber is sealed after each filling. Inventive processes for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the molded wrapping material down to a temperature T²<T¹, wherein the receiving chamber formed in step b) is filled before, during or after the cooling and then, on completion of the filling, is sealed.

d) Deforming the wrapping material by enlarging the receiving chamber formed in step b) and filling the enlarged receiving chamber, wherein the receiving chamber is resealed on completion of this filling;

are particularly preferred in the context of the present application.

A further preferred process for manufacturing a water-soluble or water-dispersible recipient having at least one receiving chamber, comprising the steps:

a) Heating a first water-soluble or water-dispersible exterior material to a temperature T¹;

b) Deforming the wrapping material to form a receiving chamber;

c) Cooling the shaped wrapping material to a temperature T²<T¹;

d) Deforming the wrapping material by enlarging the receiving chamber formed in step b) and partially filling the enlarged receiving chamber, wherein it is preferably filled with a solid;

e) Sealing the partially filled receiving chamber and filling the remaining volume of the receiving chamber, wherein it is preferably filled with a liquid and is resealed on completion of this filling;

The final product of the above described preferred processes with sealing are water-soluble or water-dispersible recipients, whose receiving chamber is split up in two regions that are separated from one another, wherein these regions are filled with preferably different fillers. The following table presents an overview of a series of particularly preferred assemblages in the context of the present application:

Recipient having two different fillers.

| Filler 1 | Filler 2 |
|---|---|
| Liquid | Liquid |
| Liquid | Powder |
| Liquid | Granule |
| Liquid | Compactate |
| Liquid | Extrudate |
| Liquid | Cast object |
| Liquid | Shape-stable gel |
| Powder | Liquid |
| Powder | Powder |
| Powder | Granule |
| Powder | Compactate |
| Powder | Extrudate |
| Powder | Cast object |
| Powder | Shape-stable gel |
| Granule | Liquid |
| Granule | Powder |
| Granule | Granule |
| Granule | Compactate |
| Granule | Extrudate |
| Granule | Cast object |
| Granule | Shape-stable gel |
| Compactate | Liquid |
| Compactate | Powder |
| Compactate | Granule |
| Compactate | Compactate |
| Compactate | Extrudate |
| Compactate | Cast object |
| Compactate | Shape-stable gel |
| Extrudate | Liquid |
| Extrudate | Powder |
| Extrudate | Granule |
| Extrudate | Compactate |
| Extrudate | Extrudate |
| Extrudate | Cast object |
| Extrudate | Shape-stable gel |
| Cast object | Liquid |
| Cast object | Powder |
| Cast object | Granule |
| Cast object | Compactate |
| Cast object | Extrudate |
| Cast object | Cast object |
| Cast object | Shape-stable gel |
| Shape-stable gel | Liquid |
| Shape-stable gel | Powder |
| Shape-stable gel | Granule |
| Shape-stable gel | Compactate |
| Shape-stable gel | Extrudate |
| Shape-stable gel | Cast object |
| Shape-stable gel | Shape-stable gel |

In the inventive process, water-soluble or water-dispersible wrapping materials are processed into water-soluble or water-dispersible recipients. In a preferred process variant, a water-soluble or water-dispersible polymer, preferably a polymer film is used as the water-soluble or water-dispersible wrapping material.

Several particularly preferred water-soluble or water-dispersible wrapping materials that are suitable for both the manufacture of the receiving chambers and also their sealing are listed below. The cited polymers can be used as the sealing or wrapping material, both alone as well as in combination with one another or in combination with further substances, for example, plasticizers or solubility enhancers.

a) water-soluble nonionic polymers from the group of

a1) polyvinyl pyrrolidones,
a2) vinyl pyrrolidone/vinyl ester-copolymers,
a3) cellulose ethers
   b) water-soluble amphoteric polymers from the group of
b1) alkylacrylamide/acrylic acid-copolymers
b2) alkylacrylamide/methacrylic acid-copolymers
b3) alkylacrylamide/methyl methacrylic acid-copolymers
b4) alkylacrylamide/acrylic acid/alkylaminoalkyl(meth)acrylic acid-copolymers
b5) alkylacrylamide/methacrylic acid/alkylaminoalkyl(meth)acrylic acid-copolymers
b6) alkylacrylamide/methyl methacrylic acid/alkylaminoalkyl(meth)acrylic acid-copolymers
b7) alkylacrylamide/alkyl methacrylic acid/alkylaminoethyl methacrylate/alkyl methacrylate-copolymers
b8) copolymers of
   b8i) unsaturated carboxylic acids,
   b8ii) cationically derivatized unsaturated carboxylic acids
   b8iii) optional additional ionic or nonionic monomers.
      c) water-soluble zwitterionic polymers from the group of
c1) acrylamidoalkyltrialkylammonium chloride/acrylic acid-copolymers as well as their alkali metal and ammonium salts
c2) acrylamidoalkyltrialkylammonium chloride/methacrylic acid-copolymers as well as their alkali metal and ammonium salts
c3) methacroylethyl betaine/methacrylate-copolymers
   d) water-soluble anionic polymers from the group of
d1) vinyl acetate/crotonic acid-copolymers
d2) vinyl pyrrolidone/vinyl acrylate-copolymers
d3) acrylic acid/ethyl acrylate/N-tert.-butylacrylamide-terpolymers
d4) grafted polymers of vinyl esters, esters of acrylic acid or methacrylic acid alone or in mixtures, copolymers with crotonic acid, acrylic acid or methacrylic acid with polyalkylene oxides and/or polyalkylene glycols
d5) grafted and crosslinked copolymers from the copolymerization of
   d5i) at least one monomer of the nonionic type,
   d5ii) at least one monomer of the ionic type,
   d5iii) polyethylene glycol, and
   d5iv) a crosslinker
d6) copolymers obtained by copolymerizing at least one monomer from each of the three following groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, straight-chain or branched C₈₋₁₈ alcohols
d7) terpolymers of crotonic acid, vinyl acetate and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters or straight chain allyl or methallyl esters
d9) crotonic acid copolymers with one or more monomers from the group consisting of ethylene, vinylbenzene, vinyl methyl ether, acrylamide and the water-soluble salts thereof
d10) terpolymers of vinyl acetate, crotonic acid and vinyl esters of a saturated aliphatic α-branched monocarboxylic acid
   e) water-soluble cationic polymers from the group of
e1) quaternized cellulose derivatives
e2) polysiloxanes with quaternary groups
e3) cationic guar derivatives
e4) polymeric dimethyldiallylammonium salts and their copolymers with esters and amides of acrylic acid and methacrylic acid
e5) copolymers of vinyl pyrrolidone with quaternized derivatives of dialkylaminoacrylate and dialkylaminomethacrylate
e6) vinyl pyrrolidone-methoimidazolinium chloride-copolymers
e7) quaternized polyvinyl alcohol
e8) polymers described by the INCI designations Polyquaternium 2, Polyquaternium 17, Polyquaternium 18 and Polyquaternium 27

Water-soluble polymers in the context of the invention are such polymers that have a solubility higher than 2.5 wt. % in water at room temperature.

The wrapping materials used in the inventive process are preferably, at least in part, a substance from the group (acetalized) polyvinyl alcohol, polyvinyl pyrrolidone, polyethylene oxide, gelatine.

In a preferred process variant, the recipient comprises one or more water-soluble polymer(s), preferably a material from the group (optionally acetalized) polyvinyl alcohol (PVAL), polyvinyl pyrrolidone, polyethylene oxide, gelatine, cellulose, and their derivatives and mixtures.

“Polyvinyl alcohols” (abbreviation PVAL, sometimes also PVOH) is the term for polymers with the general structure 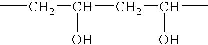
which comprise lesser amounts (approximately 2%) of structural units of the type

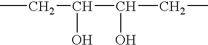

Typical commercial polyvinyl alcohols, which are offered as yellowish white powders or granules having degrees of polymerization in the range of approximately 100 to 2,500 (molar masses of approximately 4,000 to 100,000 g/mol), have degrees of hydrolysis of 98-99 or 87-89 molar % and thus still have a residual acetyl group content. The manufacturers characterize the polyvinyl alcohols by stating the degree of polymerization of the initial polymer, the degree of hydrolysis, the saponification number and/or the solution viscosity.

The solubility in water and in a few strongly polar organic solvents (formamide, dimethylformamide, dimethyl sulfoxide) of polyvinyl alcohols is a function of the degree of hydrolysis; they are not attacked by (chlorinated) hydrocarbons, esters, fats or oils. Polyvinyl alcohols are classified as toxicologically inoffensive and are at least partially biologically degradable. The solubility in water can be reduced by post-treatment with aldehydes (acetalization), by complexing with Ni salts or Cu salts or by treatment with dichromates, boric acid or borax. The coatings of polyvinyl alcohol are substantially impenetrable to gases such as oxygen, nitrogen, helium, hydrogen, carbon dioxide, but do allow water vapor to pass.

In the context of the present invention, it is preferred that the wrapping material used in the inventive process at least partially includes a polyvinyl alcohol whose degree of hydrolysis is 70 to 100 molar %, preferably 80 to 90 molar %, with particular preference from 81 to 89 molar %, and in particular, from 82 to 88 molar %. In a preferred embodiment, the first wrapping material used in the inventive process material consists of at least 20 wt. %, particularly preferably of at least 40 wt. %, quite particularly preferably of at least 60 wt. % and particularly of at least 80 wt. % of a polyvinyl alcohol, whose degree of hydrolysis ranges from 70 to 100 molar %, advantageously 80 to 90 molar %, particularly preferably 80 to 89 molar % and particularly 82 to 88 molar %.

Preferably, polyvinyl alcohols of a defined molecular weight range are used for the recipients, wherein according to the invention it is preferred that the wrapping material includes a polyvinyl alcohol whose molecular weight lies in the range 10,000 to 100,000 gmol⁻¹, advantageously from 11,000 gmol−1 to 90,000 gmol⁻¹, with particular preference from 12,000 to 80,000 gmol⁻¹, and in particular, from 13,000 to 70,000 gmol⁻¹.

The degree of polymerization of such preferred polyvinyl alcohols lies between approximately 200 to approximately 2,100, preferably between approximately 220 to approximately 1,890, with particular preference between approximately 240 to approximately 1,680, and in particular, between approximately 260 to approximately 1,500.

The above-described polyvinyl alcohols are widely commercially available, for example, under the trade name Mowiol® (Clariant). Examples of polyvinyl alcohols which are particularly suitable in the context of the present invention are Mowiol® 3-83, Mowiol® 4-88, Mowiol® 5-88, and Mowiol® 8-88.

Further polyvinyl alcohols that are particularly suitable as wrapping materials are to be found in the following table:

| | | | Melting |
|---|---|---|---|
| | Hydrolysis | Mol Wt | point |
| Name | Degree [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23.600 | 100 |
| Gohsefimer ® LL02 | 41-51 | 17.700 | 100 |

Further polyvinyl alcohols that are suitable as wrapping materials are ELVANOL® 51-05, 52-22, 50-42, 85-82, 75-15, T-25, T-66, 90-50, (trade mark of Du Pont), ALCOTEX® 72.5, 78, B72, F80/40, F88/4, F88/26, F88/40, F88/47, (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K. K.).

The water content of PVAL can be modified by post-treatment with aldehydes (acetalization) or ketones (ketalization). Polyvinyl alcohols, which are acetalized or ketalized with the aldehyde or ketone groups of saccharides or polysaccharides or their mixtures, have proved to be particularly preferred and because of their extremely good solubility in cold water, particularly advantageous. The reaction products of PVAL and starch are used most advantageously.

Moreover, the water-solubility can be adjusted and controlled to required values by complexation with Ni salts or Cu salts or by treatment with dichromates, boric acid or borax. The films of polyvinyl alcohol are substantially impenetrable to gases such as oxygen, nitrogen, helium, hydrogen, carbon dioxide, but do allow water vapor to pass.

Exemplary suitable water-soluble PVAL films are available under the trade name “SOLUBLON®” from Syntana Handelsgesellschaft E. Harke Gmbh & Co. Their solubility in water can be adjusted exactly and films of this product series are available, which are soluble in aqueous phase over all temperature ranges relevant to each application.

Polyvinyl pyrrolidones, abbreviated to PVP, can be described by means of the general formula:

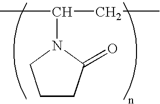

PVP are manufactured by radical polymerization of 1-vinyl pyrrolidone. Commercial PVP have molecular weights in the range 2,500 to 750,000 g/mol and are supplied as white, hygroscopic powders or as aqueous solutions.

Polyethylene oxides, abbreviated to PEOX, are polyalkylene glycols of the general formula
H—[O—CH₂—CH₂]ₙ—OH
which are manufactured industrially by the base catalyzed polyaddition of ethylene oxide (oxirane) in systems with the least possible water content with ethylene glycol as the starting molecule. They have molecular weights from approximately 200 to 5,000,000 g/mol, corresponding to degrees of polymerization n of approximately 5 to >100,000. Polyethylene oxides possess an extremely low concentration of reactive hydroxy end groups and show only weak glycol properties.

Gelatin is a polypeptide (molecular weight: approximately 15,000 to >250,000 g/mol) obtained principally by hydrolysis under acidic or alkaline conditions of the collagen present in the skin and bones of animals. The amino acid composition of gelatin corresponds largely to that of the collagen from which it was obtained, and varies as a function of its provenance. The use of gelatin as a water-soluble coating material is extremely widespread, especially in pharmacy, in the form of hard or soft gelatin capsules. Gelatin in the form of films finds only limited use, due to its high price compared with the above cited polymers.

In the context of the present invention, wrapping materials are preferred, which include a polymer from the group starch and starch derivatives, cellulose and cellulose derivatives, particularly methyl cellulose and mixtures thereof.

Starch is a homoglycan in which the glucose units are attached by α-glycoside bonds. Starch is made up of two components of different molecular weight, namely approximately 20-30% straight-chain amylose (molecular weight approximately 50,000 to 150,000) and 70-80% of branched-chain amylopectin (molecular weight approximately 300,000 to 2,000,000). Small quantities of lipids, phosphoric acid and cations are also present. Whereas the amylose—on account of the bond in the 1,4-position—forms long, helical entwisted chains containing about 300 to 1,200 glucose molecules, the amylopectin chain branches through a 1,6-bond after—on average—25 glucose units to form a branch-like structure containing about 1,500 to 12,000 glucose molecules. Besides pure starch, starch derivatives obtainable from starch by polymer-analog reactions may also be used in the context of the present invention for the production of water-soluble coatings for the detergent, rinse agent and cleaning agent portions. These chemically modified starches include, for example, products of esterification or etherification reactions in which hydroxy hydrogen atoms have been substituted. However, starches in which the hydroxy groups have been replaced by functional groups that are not attached by an oxygen atom may also be used as starch derivatives. The group of starch derivatives includes, for example, alkali metal starches, carboxymethyl starches (CMS), starch esters and ethers and amino starches.

Pure cellulose has the formal empirical composition (C₆H₁₀O₅)ₙ and, formally, is a β-1,4-polyacetal of cellobiose that, in turn, is made up of two molecules of glucose. Suitable celluloses consist of approximately 500 to 5,000 glucose units and, accordingly, have average molecular weights of 50,000 to 500,000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses.

Processes according to the invention, wherein at least one of the added wrapping materials is transparent or translucent, are preferred.

The wrapping material or the sealing material employed is preferably transparent. In the context of this invention, transparency is understood to mean that the transmittance in the visible spectrum of light (410 to 800 nm) is greater than 20%, advantageously greater than 30%, most preferably greater than 40% and in particular, greater than 50%. Thus, as soon as a wavelength of the visible spectrum of light has a transparency greater than 20%, then in the context of the invention it is to be considered as transparent.

Inventively manufactured recipients, whose manufacture employs transparent wrapping material, may also comprise a stabilizer. In the context of the invention, stabilizers are materials that protect the ingredients in the receiving chamber from decomposition or deactivation by light irradiation. Antioxidants, UV-absorbers and fluorescent dyes have proven to be particularly suitable.

In the context of the invention, antioxidants are particularly suitable stabilizers. The formulations can comprise antioxidants in order to prevent undesirable changes to the formulation caused by light irradiation and radically induced decomposition. Phenols, bisphenols and thiobisphenols, substituted with sterically hindered groups can be used, for example, as antioxidants. Further examples are propyl gallate, butylhydroxytoluene (BHT), butylhydroxyanisole (BHA), t-butyl hydroquinone (TBHQ), tocopherol and the long-chained (C₈-C₂₂) esters of gallic acid, such as dodecyl gallate. Other substance classes are aromatic amines, preferably secondary aromatic amines and substituted p-phenylenediamines, phosphorus compounds with trivalent phosphorus such as phosphines, phosphites and phosphonites, citric acids and citric acid derivatives, such as isopropyl citrate, compounds with ene-diol groups, so-called reductonesa, such as ascorbic acid and its derivatives, such as ascorbic acid palmitate, organosulfur compounds, such as the esters of 3,3′-thiodipropionic acid with C₁₋₁₈-alkanols, particularly C₁₀₋₁₈-alkanols, metal deactivators, which are capable of complexing autoxidative catalytic metal ions such as copper, like nitriloacetic acid and its derivatives and their mixtures. The antioxidants can be comprised in the formulations in amounts up to 35 wt. %, preferably up to 25 wt. %, particularly preferably from 0.01 to 20 and particularly from 0.03 to 20 wt. %.

A further class of preferred suitable stabilizers are the UV-absorbers. UV-absorbers can improve the light stability of the ingredients of the composition. UV-absorbers are understood to mean organic substances (light protective filters), which are able to absorb UV radiation and emit the resulting energy in the form of longer wavelength radiation, for example, as heat. Compounds, which possess these desired properties, are, for example, the efficient radiationless deactivating compounds and derivatives of benzophenone having substituents in position(s) 2- and/or 4. Also suitable are substituted benzotriazoles, such as, for example, the water-soluble sodium salt of 3-(2H-benzotriazole-2-yl)-4-hydroxy-5-(methylpropyl)-benzenesulfonic acid (Cibafast® H), acrylates, which are phenyl-substituted in position 3 (cinnamic acid derivatives) optionally with cyano groups in position 2, salicylates, organic Ni complexes, as well as natural substances such as umbelliferone and the endogenous urocanic acid. The biphenyl and above all the stilbene derivatives which are commercially available as Tinosorb® FD or Tinosorb® FR from Ciba, are of particular importance. As UV-B absorbers can be cited: 3-benzylidene camphor or 3-benzylidene norcamphor and its derivatives, for example, 3-(4-methylbenzylidene) camphor, 4-aminobenzoic acid derivatives, preferably the 2-ethylhexyl ester of 4-(dimethylamino)benzoic acid, 4-(dimethylamino)benzoic acid, 2-octyl ester and 4-(dimethylamino)benzoic acid, amyl ester; esters of cinnamic acid, preferably 4-methoxycinnamic acid, 2-ethylhexyl ester, 4-methoxycinnamic acid, propyl ester, 4-methoxycinnamic acid, isoamyl ester, 2-cyano-3,3-phenylcinnamic acid, 2-ethylhexyl ester (octocrylene); esters of salicylic acid, preferably salicylic acid, 2-ethylhexyl ester, salicylic acid, 4-isopropylbenzyl ester, salicylic acid, homomethyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzmalonic acid, di-2-ethylhexylester; triazine derivatives, such as, for example, 2,4,6-trianilino-(p-carbo-2′-ethyl-1′-hexyloxy)-1,3,5-triazine and octyl triazone, or dioctyl butamidotriazone (Uvasorb® HEB); propane-1,3-dione, such as, for example, 1-(4-tert.-butylphenyl)-3-(4′-methoxyphenyl)propane-1,3-dione; ketotricyclo (5.2.1.0) decane derivatives. Further suitable are 2-phenylbenzimidazole-5-sulfonic acid and its alkali metal-, alkaline earth metal-, ammonium-, alkyl ammonium-, alkanol ammonium- and glucammonium salts; sulfonic acid derivatives of benzophenones, preferably 2-hydroxy-4-methoxybenzophenone-5-sulfonic acid and its salts; sulfonic acid derivatives of 3-benzylidene camphor, such as, for example, 4-(2-oxo-3-bornylidenemethyl)benzene sulfonic acid and 2-methyl-5-(2-oxo-3-bornylidene) sulfonic acid and its salts.

Typical UV-A filters particularly include derivatives of benzoylmethane, such as, for example, 1-(4′-tert.-butylphenyl)-3-(4′-methoxyphenyl)propane-1,3-dione, 4-tert.-butyl-4′-methoxydibenzoylmethane (Parsol 1789), 1-phenyl-3-(4′-isopropylphenyl)-propane-1,3-dione as well as enamine compounds. Naturally, the UV-A and UV-B filters can also be added as mixtures. Beside the cited soluble materials, insoluble, light-protecting pigments, namely finely dispersed, preferably, nano metal oxides or salts can also be considered for this task. Exemplary suitable metal oxides are particularly zinc oxide and titanium oxide and also oxides of iron, zirconium, silicon, manganese, aluminum and cerium as well as their mixtures. Silicates (talc), barium sulfate or zinc stearate can be added as salts. The oxides and salts are already used in the form of pigments for skin care and skin protecting emulsions and decorative cosmetics. Here, the particles should have a mean diameter of less than 100 nm, preferably between 5 and 50 nm and especially between 15 and 30 nm. They can be spherical, however elliptical or other shaped particles can also be used. The pigments can also be surface treated, i.e. hydrophilized or hydrophobized. Typical examples are coated titanium dioxides, such as, for example, Titandioxid T 805 (Degussa) or Eusolex® T2000 (Merck). Hydrophobic coating agents preferably include silicones and among them specifically trialkoxyoctylsilanes or simethicones. Micronized zinc oxide is preferably used.

The UV absorbers can be comprised in quantities up to 5 wt. %, advantageously up to 3 wt. %, particularly preferably 0.01 wt. % to 2.0 and particularly from 0.03 wt. % to 1 wt. %, each based on the total weight of a mixture of substances present in a receiving chamber.

A further preferred class of stabilizers are the fluorescent dyes. They include 4,4′-diamino-2,2′-stilbenedisulfonic acids (flavonic acids), 4,4′-distyrylbiphenylene, methylumbelliferone, coumarine, dihydroquinolinones, 1,3-diarylpyrazolines, naphthoic acid imide, benzoxazole-, benzisoxazole- and benzimidazole-systems as well as heterocyclic substituted pyrene derivatives. The sulfonic acid salts of diaminostilbene derivatives and polymeric fluorescent dyes are of particular importance.

The fluorescent dyes can be comprised in quantities up to 5 wt. %, advantageously up to 1 wt. %, particularly preferably 0.01 wt. % to 0.5 and particularly from 0.03 wt. % to 0.1 wt. %, each based on the total weight of a mixture of substances present in a receiving chamber.

In a preferred embodiment, the above-mentioned stabilizers are used in any mixtures. The stabilizers are used in quantities up to 40 wt. %, advantageously up to 30 wt. %, particularly preferably 0.01 wt. % to 20 wt. % and particularly from 0.02 wt. % to 5 wt. %, each based on the total weight of a mixture of substances present in a receiving chamber.

In a preferred inventive process, at least one of the employed wrapping material(s) consists of a water-soluble or water-dispersible polymer, preferably a polymer film.

Preferred process variants are those wherein film used in step a) of the inventive process has a thickness of 5 to 2,000 μm, advantageously 10 to 1,000 μm, particularly preferably 15 to 500 μm, quite particularly preferably 20 to 200 μm and particularly 25 to 100 μm.

The films can be a single or multilayered film (laminate film). The water content of the films is preferably below 10 wt. %, particularly preferably below 7 wt. %, quite particularly preferably below 5 wt. % and especially below 4 wt. %.

The water-soluble or water-dispersible recipients manufactured according to the invention are suitable for packaging the most varied active substances. Inventive processes, in which the receiving chamber(s) is/are filled with an active substance or a mixture of active substances from the pharmaceutical, cosmetic, food, plant protection or fertilizer fields, adhesives and/or body care substances, preferably, however, from the field of detergent and cleansing agent active substances, are preferred in the context of the present application.

Preferably, the agents manufactured according to the above described process, comprise detergent and cleansing agent active substances, preferably detergent and cleansing agent active substances from the group of builders, surfactants, polymers, bleaching agents, bleach activators, enzymes, glass corrosion inhibitors, corrosion inhibitors, disintegration auxiliaries, fragrances and perfume carriers. These preferred ingredients are more closely described below.

Builders.

The builders include especially the zeolites, silicates, carbonates, organic co-builders and also—where there are no ecological reasons preventing their use—phosphates.

Of the suitable fine crystalline, synthetic zeolites containing bound water, zeolite A and/or P are preferred. A particularly preferred zeolite P is zeolite MAP® (a commercial product of Crosfield). However, the zeolites X as well as mixtures of A, X and/or P are also suitable. Commercially available and preferred in the context of the present invention is, for example, also a co-crystallizate of zeolite X and zeolite A (approximately 80 wt. % zeolite X), which is marketed under the name of VEGOBOND AX® by Condea Augusta S.p.A. and which can be described by the formula
nNa₂O.(1-n)K₂O.Al₂O₃.(2-2.5)SiO₂.(3.5-5.5)H₂O

The zeolite can be added both as the builder in a granular compound as well as being used as a type of ‘dusting’ of a granular mixture, preferably a mixture to be pressed, wherein normally, both ways are used to incorporate the zeolite in the premix. Suitable zeolites have an average particle size of less than 10 μm (test method: volumetric distribution Coulter counter) and preferably comprise 18 to 22 wt. %, particularly 20 to 22 wt. % of bound water.

Suitable crystalline, layered sodium silicates correspond to the general formula NaMSiₓO₂ₓ₊₁.H₂O, wherein M is sodium or hydrogen, x is a number from 1.9 to 4 and y is a number from 0 to 20, preferred values for x being 2, 3 or 4. Preferred crystalline-layered silicates of the given formula, are those in which M stands for sodium and x assumes the values 2 or 3. Both β- and δ-sodium disilicates Na₂Si₂O₅.yH₂O are preferred.

When the silicates are incorporated as a component of dishwasher detergents t, then they preferably comprise at least one crystalline layer-forming silicate of the general formula NaMSiₓO₂ₓ₊₁.yH₂O, wherein M represents sodium or hydrogen, x is a number from 1.9 to 22, preferably 1.9 to 4 and y stands for a number from 0 to 33. The crystalline layer-forming silicates of the formula NaMSiₓO₂ₓ₊₁.yH₂O are marketed, for example, by Clariant GmbH (Germany) under the trade names Na-SKS. Examples of these silicates are Na-SKS-1, (Na₂Si₂₂O₄₅.xH₂O, Kenyait), Na-SKS-2 (Na₂Si₁₄O₂₉.xH₂O, Magadiit), Na-SKS-3 (Na₂Si₈O₁₇.xH₂O) or Na-SKS-4 (Na₂Si₄O₉.xH₂O, Makatit).

Crystalline, layered silicates of formula NaMSiₓO₂ₓ₊₁, in which x stands for 2, are particularly suitable for the purposes of the present invention. Na-SKS-5 (α-Na₂Si₂O₅), Na-SKS-7 (β-Na₂Si₂O₅, Natrosilit), Na-SKS-9 (NaHSi₂O₅.H₂O), Na-SKS-10 (NaHSi₂O₅.3H₂O, Kanemit), Na-SKS-11 (t-Na₂Si₂O₅) and Na-SKS-13 (NaHSi₂O₅), are most notably suitable, particularly, however, Na-SKS-6 (δ-Na₂Si₂O₅).

If silicates are incorporated as components of dishwasher detergents, then these agents comprise a content by weight of crystalline layered silicates of formula NaMSiₓO2ₓ₊₁.yH₂O of 0.1 to 20 wt. %, preferably 0.2 to 15 wt. % and particularly 0.4 to 10 wt. %, each based on the total weight of the agent. Particularly preferred are especially those dishwasher detergents that have a total silicate content below 7 wt. %, advantageously below 6 wt. %, preferably below 5 wt. %, particularly preferably below 4 wt. %, quite particularly preferably below 3 wt. % and especially below 2.5 wt. %, wherein this silicate, based on the total weight of the comprised silicate is advantageously at least 70 wt. %, preferably at least 80 wt. % and especially at least 90 wt. % of a silicate of the general formula NaMSiₓO₂ₓ₊₁.yH₂O.

Other useful builders are amorphous sodium silicates with a modulus (Na₂O:SiO₂ ratio) of 1:2 to 1:3.3, preferably 1:2 to 1:2.8 and especially 1:2 to 1:2.6, which dissolve with a delay and exhibit multiple wash cycle properties. The delay in dissolution compared with conventional amorphous sodium silicates can have been obtained in various ways, for example, by surface treatment, compounding, compressing/compacting or by over-drying. In the context of this invention, the term “amorphous” also means “X-ray amorphous”. In other words, the silicates do not produce any of the sharp X-ray reflections typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. This type of X-ray amorphous silicates similarly possesses a delayed dissolution in comparison with the customary water glasses. Compacted/dense amorphous silicates, compounded amorphous silicates and over dried X-ray-amorphous silicates are particularly preferred.

In the context of the present invention, detergents and cleansing agents preferably comprise silicate(s), preferably alkali silicates, particularly preferably crystalline or amorphous alkali disilicates in quantities of 10 to 60 wt. %, preferably 15 to 50 wt. % and especially 20 to 40 wt. %, each based on the weight of the detergent or cleansing agent.

Naturally, the generally known phosphates can also be added as builders, in so far that their use should not be avoided on ecological grounds. This is particularly true for the employment of the inventive agent as the dishwasher detergent, as is particularly preferred in the context of the present application. In the detergent and cleansing agent industry, among the many commercially available phosphates, the alkali metal phosphates are the most important and pentasodium or pentapotassium triphosphates (sodium or potassium tripolyphosphate) are particularly preferred.

“Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: They act as alkalinity sources, prevent lime deposits on machine parts and lime incrustations in fabrics and, in addition, contribute towards the cleansing power.

Exemplary suitable phosphates are sodium dihydrogen phosphate, NaH₂PO₄, in the form of the dihydrate (density 1.91 gcm⁻³, melting point 60° C.) or in the form of the monohydrate (density 2.04 gcm⁻³), disodium hydrogen phosphate (secondary sodium phosphate) Na₂HPO₄, that can be added in anhydrous form or with 2 mole (density 2.066 gcm⁻³, water loss at 95° C.), 7 mole (density 1.68 gcm⁻³, melting point 48° C. losing 5H₂O) and 12 mole water (density 1.52 gcm⁻³, melting point 35° C. losing 5H₂O), in particular, however, trisodium phosphate (tertiary sodium phosphate) Na₃PO₄, that can be added as the dodecahydrate, as the decahydrate (corresponding to 19-20% P₂O₅) and in anhydrous form (corresponding to 39-40% P₂O₅).

A further preferred phosphate is tripotassium phosphate (tertiary or tribasic potassium phosphate), K₃PO₄. Further preferred is tetrasodium diphosphate (sodium pyrophosphate), Na₄P₂O₇, which exists in anhydrous form (density 2.534 gcm⁻³, melting point 988°, a figure of 880° has also been mentioned) and as the decahydrate (density 1.815-1.836 gcm⁻³, melting point 94° with loss of water), as well as the corresponding potassium salt potassium diphosphate (potassium pyrophosphate) K₄P₂O₇.

The industrially important pentasodium triphosphate, Na₅P₃O₁₀ (sodium tripolyphosphate), is anhydrous or crystallizes with 6H₂O to a non-hygroscopic, white, water-soluble salt of the general formula NaO—[P(O)(ONa)—O]ₙ—Na where n=3. The corresponding potassium salt, pentapotassium triphosphate K₅P₃O₁₀ (potassium tripolyphosphate), is commercialized, for example, in the form of a 50 wt. % solution (>23% P₂O₅, 25% K₂O). The potassium polyphosphates are widely used in the detergent industry. Sodium potassium tripolyphosphates also exist and are also usable in the scope of the present invention. They are formed, for example, when sodium trimetaphosphate is hydrolyzed with KOH:
(NaPO₃)₃+2KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

In the context of the present invention, if phosphates are incorporated as the active detergent or cleansing substances in detergents or cleansing agents, then preferred agents comprise this phosphate(s), preferably alkali metal phosphate(s), particularly preferably pentasodium or pentapotassium triphosphate (sodium or potassium triphosphate) in quantities of 5 to 80 wt. %, preferably 15 to 75 wt. % and especially 20 to 70 wt. %, each based on the weight of the detergent or cleansing agent.

It is particularly preferred to incorporate potassium tripolyphosphate and sodium tripolyphosphate in a proportion by weight of greater than 1:1, preferably greater than 2:1, more preferably greater than 5:1, particularly preferably greater than 10:1 and especially greater than 20:1. It is particularly preferred to incorporate exclusively potassium tripolyphosphate without the addition of other phosphates.

Further builders are the alkalinity sources. Alkali metal hydroxides, alkali metal carbonates, alkali metal hydrogen carbonates, alkali metal sesquicarbonates, the cited alkali silicates, alkali metal silicates and mixtures of the cited materials are examples of alkalinity sources that can be used, the alkali carbonates being preferably used, especially sodium carbonate, sodium hydrogen carbonate or sodium sesquicarbonate in the context of this invention. A builder system comprising a mixture of tripolyphosphate and sodium carbonate is particularly preferred. A builder system comprising a mixture of tripolyphosphate and sodium carbonate and sodium disilicate is also particularly preferred. Because of their low chemical compatibility—in comparison with other builders—with the usual ingredients of detergents and cleansing agents, the alkali metal hydroxides are preferably only incorporated in low amounts, advantageously in amounts below 10 wt. %, preferably below 6 wt. %, particularly preferably below 4 wt. % and particularly below 2 wt. %, each based on the total weight of the detergent or cleansing agent. Agents that comprise less than 0.5 wt. %, based on the total weight, and in particular, no alkali metal hydroxide, are particularly preferred.

Particularly preferred detergents and cleansing agents comprise carbonate(s) and/or hydrogen carbonate(s), preferably alkali carbonate(s), particularly preferably sodium carbonate in quantities of 2 to 50 wt. %, preferably 5 to 40 wt. % and especially 7.5 to 30 wt. %, each based on the weight of the detergent or cleansing agent. Particularly preferred agents, based on the weight of the detergent or cleansing agent, comprise less than 20 wt. %, advantageously less than 17 wt. %, preferably less than 13 wt. % and particularly less than 9 wt. % carbonate(s) and/or hydrogen carbonate(s), preferably alkali carbonates, particularly preferably sodium carbonate.

Organic co-builders include, in particular, polycarboxylates/polycarboxylic acids, polymeric polycarboxylates, aspartic acid, polyacetals, dextrins, other organic co-builders (see below) and phosphonates. These classes of substances are described below.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of polycarboxylic acids such as citric acid, adipic acid, succinic acid, glutaric acid, tartaric acid, sugar acids and mixtures thereof.

Acids per se can also be used. Besides their building effect, the acids also typically have the property of an acidifying component and, hence, also serve to establish a relatively low and mild pH in detergents and cleansing agents. Citric acid, succinic acid, glutaric acid, adipic acid, gluconic acid and any mixtures thereof are particularly mentioned in this regard.

Other suitable builders are additional polymeric polycarboxylates, for example, the alkali metal salts of polyacrylic or polymethacrylic acid, for example, those with a relative molecular weight of 500 to 70,000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as standard. The molecular weights measured against polystyrene sulfonic acids are generally significantly higher than the molecular weights mentioned in this specification.

Particularly suitable polymers are polyacrylates, which preferably have a molecular weight of 2,000 to 20,000 g/mol. By virtue of their superior solubility, preferred representatives of this group are again the short-chain polyacrylates, which have molecular weights of 2,000 to 10,000 g/mol and, more particularly, 3,000 to 5,000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2,000 to 70,000 g/mol, preferably 20,000 to 50,000 g/mol and especially 30,000 to 40,000 g/mol.

The (co)polymeric polycarboxylates can be added either as powders or as aqueous solutions. The (co)polymeric polycarboxylate content of the detergents or cleansing agents is preferably from 0.5 to 20% by weight, in particular, from 3 to 10% by weight.

In order to improve the water solubility, the polymers can also comprise allylsulfonic acids as monomers, such as, for example, allyloxybenzenesulfonic acid and methallylsulfonic acid

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Other preferred copolymers are those, which preferably contain acrolein and acrylic acid/acrylic acid salts or acrolein and vinyl acetate as monomers.

Similarly, other preferred builders are polymeric aminodicarboxylic acids, salts or precursors thereof. Polyaspartic acids or their salts and are particularly preferred.

Further preferred builders are polyacetals that can be obtained by treating dialdehydes with polyol carboxylic acids that possess 5 to 7 carbon atoms and at least 3 hydroxyl groups. Preferred polyacetals are obtained from dialdehydes like glyoxal, glutaraldehyde, terephthalaldehyde as well as their mixtures and from polycarboxylic acids like gluconic acid and/or glucoheptonic acid.

Further suitable organic builders are dextrins, for example, oligomers or polymers of carbohydrates that can be obtained by the partial hydrolysis of starches. The hydrolysis can be carried out using typical processes, for example, acidic or enzymatic catalyzed processes. The hydrolysis products preferably have average molecular weights in the range 400 to 500,000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2,000 to 30,000 g/mol may be used.

The oxidized derivatives of such dextrins concern their reaction products with oxidizing agents that are capable of oxidizing at least one alcohol function of the saccharide ring to the carboxylic acid function.

Oxydisuccinates and other derivatives of disuccinates, preferably ethylenediamine disuccinate are also further suitable cobuilders. Ethylenediamine-N,N′-disuccinate (EDDS) is preferably used here in the form of its sodium or magnesium salts. In this context, glycerin disuccinates and glycerin trisuccinates are also preferred. Suitable addition quantities in zeolite-containing and/or silicate-containing formulations range from 3 to 15% by weight.

Other useful organic co-builders are, for example, acetylated hydroxycarboxylic acids and salts thereof which optionally may also be present in lactone form and which contain at least 4 carbon atoms, at least one hydroxyl group and at most two acid groups.

In addition, any compounds capable of forming complexes with alkaline earth metal ions may be used as co-builders.

Surfactants.

The group of surfactants includes the nonionic, the anionic, the cationic and the amphoteric surfactants.

All nonionic surfactants known to the person skilled in the art can be used as the nonionic surfactants. Preferred nonionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear groups from alcohols of natural origin with 12 to 18 carbon atoms, e.g., from coco-, palm-, tallow- or oleyl alcohol, and an average of 2 to 8 EO per mole alcohol. Exemplary preferred ethoxylated alcohols include C₁₂₋₁₄-alcohols with 3 EO or 4 EO, C₉₋₁₁-alcohols with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, as well as mixtures of C₁₂₋₁₄-alcohol with 3 EO and C₁₂₋₁₈-alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these nonionic surfactants, fatty alcohols with more than 12 EO can also be used. Examples of these are tallow fatty alcohol with 14 EO, 25 EO, 30 EO or 40 EO.

Furthermore, as additional nonionic surfactants, alkyl glycosides that satisfy the general formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred nonionic surfactants which may be used, either as the sole nonionic surfactant or in combination with other nonionic surfactants, are alkoxylated, preferably ethoxylated or ethoxylated and propoxylated fatty acid alkyl esters preferably containing 1 to 4 carbon atoms in the alkyl chain.

Nonionic surfactants of the amine oxide type, for example, N-coco alkyl-N,N-dimethylamine oxide and N-tallow alkyl-N,N-dihydroxyethylamine oxide, and the fatty acid alkanolamides may also be suitable. The quantity in which these nonionic surfactants are used is preferably no more than the quantity in which the ethoxylated fatty alcohols are used and, particularly no more than half that quantity.

Other suitable surfactants are polyhydroxyfatty acid amides corresponding to the formula (V), 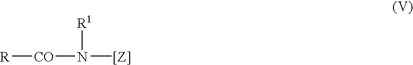
in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the formula 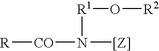
in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxy groups, or alkoxylated, preferably ethoxylated or propoxylated derivatives of that group.

[Z] is preferably obtained by reductive amination of a reducing sugar, for example, glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The preferred surfactants are weakly foaming nonionic surfactants. Detergents or cleansing agents, particularly cleansing agents for automatic dishwashers, are especially preferred when they comprise nonionic surfactants, particularly nonionic surfactants from the group of the alkoxylated alcohols. Preferred nonionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear groups from alcohols of natural origin with 12 to 18 carbon atoms, e.g., from coco-, palm-, tallow- or oleyl alcohol, and an average of 2 to 8 EO per mole alcohol. Exemplary preferred ethoxylated alcohols include C₁₂₋₁₄-alcohols with 3 EO or 4EO, C₉₋₁₁-alcohols with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, as well as mixtures of C₁₂₋₁₄-alcohol with 3 EO and C₁₂₋₁₈-alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these nonionic surfactants, fatty alcohols with more than 12 EO can also be used. Examples of these are tallow fatty alcohol with 14 EO, 25 EO, 30 EO or 40 EO.

Moreover, surfactant(s) that comprise one or more tallow fat alcohols with 20 to 30 EO in combination with a silicone defoamer are particularly preferably used.

Nonionic surfactants from the group of the alkoxylated alcohols, particularly preferably from the group of the mixed alkoxylated alcohols and especially from the group of the EO-AO-EO-nonionic surfactants are likewise incorporated with particular preference.

Nonionic surfactants that have a melting point above room temperature are used with particular preference. Nonionic surfactant(s) with a melting point above 20° C., preferably above 25° C., particularly preferably between 25 and 60° C. and, especially between 26.6 and 43.3° C., are particularly preferred.

Suitable nonionic surfactants with a melting and/or softening point in the cited temperature range are, for example, weakly foaming nonionic surfactants that can be solid or highly viscous at room temperature. If nonionic surfactants are used that are highly viscous at room temperature, they preferably have a viscosity above 20 Pas, particularly preferably above 35 Pas and especially above 40 Pas. Nonionic surfactants that have a waxy consistency at room temperature are also preferred.

Preferred nonionic surfactants that are solid at room temperature are used and belong to the groups of alkoxylated nonionic surfactants, more particularly ethoxylated primary alcohols, and mixtures of these surfactants with structurally more complex surfactants, such as polyoxypropylene/polyoxyethylene/polyoxypropylene (PO/EO/PO) surfactants. Such (PO/EO/PO)-nonionic surfactants are characterized in addition as having good foam control

In one preferred embodiment of the present invention, the nonionic surfactant with a melting point above room temperature is an ethoxylated nonionic surfactant that results from the reaction of a monohydroxyalkanol or alkylphenol containing 6 to 20 carbon atoms with preferably at least 12 moles, particularly preferably at least 15 moles and especially at least 20 moles of ethylene oxide per mole of alcohol or alkylphenol.

A particularly preferred nonionic surfactant that is solid at room temperature is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these nonionic surfactants, the so-called narrow range ethoxylates (see above) are particularly preferred.

Accordingly, ethoxylated nonionic surfactant(s) prepared from C₆₋₂₀-monohydroxy alkanols or C₆₋₂₀-alkyl phenols or C₁₂₋₂₀-fatty alcohols and more than 12 mole, preferably more than 15 mole and especially more than 20 mole ethylene oxide per mole alcohol, are used with particular preference.

Preferably, the room temperature solid nonionic surfactant additionally has propylene oxide units in the molecule. These PO units preferably make up as much as 25% by weight, more preferably as much as 20% by weight and, especially up to 15% by weight of the total molecular weight of the nonionic surfactant. Particularly preferred nonionic surfactants are ethoxylated monohydroxyalkanols or alkylphenols, which have additional polyoxyethylene-polyoxypropylene block copolymer units. The alcohol or alkylphenol component of these nonionic surfactant molecules preferably makes up more than 30 wt. %, more preferably more than 50 wt. % and most preferably more than 70 wt. % of the total molecular weight of these nonionic surfactants. Preferred agents are characterized in that they comprise ethoxylated and propoxylated nonionic surfactants, in which the propylene oxide units in the molecule preferably make up as much as 25% by weight, more preferably as much as 20% by weight and, especially up to 15% by weight of the total molecular weight of the nonionic surfactant.

Other particularly preferred nonionic surfactants with melting points above room temperature contain 40 to 70% of a polyoxypropylene/polyoxyethylene/polyoxypropylene block polymer blend that contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylolpropane and containing 24 moles of ethylene oxide and 99 moles of propylene oxide per mole of trimethylolpropane.

Nonionic surfactants, which may be used with particular advantage, are obtainable, for example, under the name of Poly Tergent® SLF-18 from Olin Chemicals.

Surfactant(s) of the formula
R¹O[CH₂CH(CH₃)O]ₓ[CH₂CH₂O]_{y}CH₂CH(OH)R²
in which R¹ stands for a linear or branched aliphatic hydrocarbon group with 4 to 18 carbon atoms or mixtures thereof, R² means a linear or branched hydrocarbon group with 2 to 26 carbon atoms or mixtures thereof and x stands for values between 0.5 and 1.5 and y stands for a value of at least 15 is/are a further particularly preferred nonionic surfactant.

Other preferred nonionic surfactants are the end-capped poly(oxyalkylated) nonionic surfactants corresponding to the following formula
R¹O[CH₂CH(R³)O]ₓ[CH₂]ₖCH(OH)[CH₂]ⱼOR²
in which R¹ and R² stand for linear or branched, saturated or unsaturated, aliphatic or aromatic hydrocarbon groups with 1 to 30 carbon atoms, R³ stands for H or for a methyl, ethyl, n-propyl, isopropyl, n-butyl, 2-butyl or 2-methyl-2-butyl group, x stands for values between 1 and 30, k and j for values between 1 and 12, preferably between 1 and 5. Each R³ in the above formula R¹O[CH₂CH(R³)O]ₓ[CH₂]ₖCH(OH)[CH₂]ⱼOR² can be different for the case where x≧2. R¹ and R² are preferably linear or branched, saturated or unsaturated, aliphatic or aromatic hydrocarbon groups containing 6 to 22 carbon atoms, groups containing 8 to 18 carbon atoms being particularly preferred. H, —CH₃ or —CH₂CH₃ are particularly preferred for the group R³. Particularly preferred values for x are in the range from 1 to 20 and more particularly in the range from 6 to 15.

As described above, each R³ in the above formula can be different for the case where x≧2. By this means, the alkylene oxide unit in the straight brackets can be varied. If, for example, x has a value of 3, the substituent R³ may be selected to form ethylene oxide (R³═H) or propylene oxide (R³═CH₃) units which may be joined together in any order, for example, (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to
R¹O[CH₂CH(R³)O]ₓCH₂CH(OH)CH₂OR²
In this last formula, R¹, R² and R³ are as defined above and x stands for a number from 1 to 30, preferably 1 to 20 and especially 6 to 18. Surfactants in which the substituents R¹ and R² have 9 to 14 carbon atoms, R³ stands for H and x assumes a value of 6 to 15 are particularly preferred.

In summary, end-capped poly(oxyalkylated) nonionic surfactants corresponding to the formula
R¹O[CH₂CH(R³)O]ₓ[CH₂]ₖCH(OH)[CH₂]ⱼOR²,
in which R¹ and R² stand for linear or branched, saturated or unsaturated, aliphatic or aromatic hydrocarbon groups with 1 to 30 carbon atoms, R³ stands for H or for a methyl, ethyl, n-propyl, isopropyl, n-butyl, 2-butyl or 2-methyl-2-butyl group, x stands for values between 1 and 30, k and j for values between 1 and 12, preferably between 1 and 5, are preferred, wherein surfactants of the type
R¹O[CH₂CH(R³)O]ₓCH₂CH(OH)CH₂OR²
in which x stands for numbers from 1 to 30, preferably 1 to 20 and especially 6 to 18, are particularly preferred.

Particularly preferred nonionic surfactants in the context of the present invention have proved to be weakly foaming nonionic surfactants, which have alternating ethylene oxide and alkylene oxide units. Among these, the surfactants with EO-AO-EO-AO blocks are again preferred, wherein one to ten EO or AO groups respectively are linked together, before a block of the other groups follows. Here, nonionic surfactants of the general formula 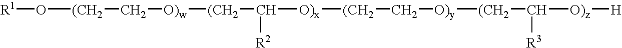
are preferred, in which R¹ stands for a linear or branched, saturated or mono- or polyunsaturated C₆₋₂₄-alkyl or alkenyl group, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

The preferred nonionic surfactants of the previous formula can be manufactured by known methods from the corresponding alcohols R¹—OH and ethylene- or alkylene oxide. The group R¹ in the previous formula can vary depending on the origin of the alcohol. When natural sources are used, the group R¹ has an even number of carbon atoms and generally is not branched, the linear alcohols of natural origin with 12 to 18 carbon atoms, for example, coconut, palm, tallow or oleyl alcohol being preferred. The alcohols available from synthetic sources are, for example, Guerbet alcohols or mixtures of methyl branched in the 2-position or linear and methyl branched groups, as are typically present in oxo alcohols. Independently of the type of alcohol used for the manufacture of the nonionic surfactants comprised in the agents, nonionic surfactants are preferred, wherein R¹ in the previous formula stands for an alkyl group with 6 to 24, preferably 8 to 20, particularly preferably 9 to 15 and particularly 9 to 11 carbon atoms.

In addition to propylene oxide, especially butylene oxide can be the alkylene oxide unit that alternates with the ethylene oxide unit in the preferred nonionic surfactants. However, also other alkylene oxides are suitable, in which R² or R³ independently of one another are selected from —CH₂CH₂—CH₃ or CH(CH₃)₂. Preferably, nonionic surfactants of the previous formula are used, in which R² or R³ stand for a group —CH₃, w and x independently of one another stand for values of 3 or 4 and y and z independently of one another stand for values of 1 or 2.

In summary, especially nonionic surfactants are preferred that have a C₉₋₁₅-alkyl group with 1 to 4 ethylene oxide units, followed by 1 to 4 propylene oxide units, followed by 1 to 4 ethylene oxide units, followed by 1 to 4 propylene oxide units. These surfactants exhibit the required low viscosity in aqueous solution and according to the invention are used with particular preference.

Other preferred nonionic surfactants are the end-capped poly(oxyalkylated) nonionic surfactants corresponding to the following formula
R¹O[CH₂CH(R³)O]ₓR²
in which R¹ stands for linear or branched, saturated or unsaturated, aliphatic or aromatic hydrocarbon groups with 1 to 30 carbon atoms, R² for linear or branched, saturated or unsaturated, aliphatic or aromatic hydrocarbon groups with 1 to 30 carbon atoms, which preferably contains 1 to 5 hydroxyl groups and preferably is also functionalized with an ether group, R³ stands for H or for a methyl, ethyl, n-propyl, isopropyl, n-butyl, 2-butyl or 2-methyl-2-butyl group, x has a value between 1 and 40.

Surfactant(s) of the general formula
R¹O[CH₂CH(R³)O]ₓR²,
in which R¹ stands for linear or branched, saturated or unsaturated, aliphatic or aromatic hydrocarbon groups with 1 to 30 carbon atoms, R² for linear or branched, saturated or unsaturated, aliphatic or aromatic hydrocarbon groups with 1 to 30 carbon atoms, which preferably contain 1 to 5 hydroxyl groups and are preferably also functionalized with an ether group, R³ stands for H or for a methyl, ethyl, n-propyl, isopropyl, n-butyl, 2-butyl or 2-methyl-2-butyl group and x has a value between 1 and 40, are likewise preferred.

In a particularly preferred embodiment of the present application, R³ stands for H in the above-cited general formula. From the group of the resulting end capped polyoxyalkylated nonionic surfactants of formula
R¹O[CH₂CH₂O]ₓR²
those nonionic surfactants are particularly preferred, in which R¹ stands for linear or branched, saturated or unsaturated, aliphatic or aromatic hydrocarbon radicals with 1 to 30 carbon atoms, preferably with 4 to 20 carbon atoms, R² for linear or branched, saturated or unsaturated, aliphatic or aromatic hydrocarbon radicals with 1 to 30 carbon atoms, which preferably contains 1 to 5 hydroxy groups and x has a value of 1 to 40.

In particular, those end capped polyoxyalkylated nonionic surfactants are preferred that according to the formula
R¹O[CH₂CH₂O]ₓCH₂CH(OH)R²
besides a group R¹ that stands for linear or branched, saturated or unsaturated, aliphatic or aromatic hydrocarbon groups with 1 to 30 carbon atoms, preferably 4 to 20 carbon atoms, further comprise a linear or branched, saturated or unsaturated, aliphatic or aromatic hydrocarbon group R² with 1 to 30 carbon atoms that is neighboring an intermediate group —CH₂CH(OH)—. In this formula, x stands for a number between 1 and 90.

In the context of the present application, such nonionic surfactant(s) of the general formula
R¹O[CH₂CH₂O]ₓCH₂CH(OH)R²
are preferred, which in addition to a radical R¹ that stands for linear or branched, saturated or unsaturated, aliphatic or aromatic hydrocarbon groups with 1 to 30 carbon atoms, preferably 4 to 20 carbon atoms, additionally comprise a linear or branched, saturated or unsaturated, aliphatic or aromatic hydrocarbon group R² with 1 to 30 carbon atoms that is neighboring a monohydroxylated intermediate group —CH₂CH(OH)— and in which x stands for a number between 1 and 90.

Nonionic surfactants of the general formula
R¹O[CH₂CH₂O]ₓCH₂CH(OH)R²,
are particularly preferred, which in addition to a group R¹ that stands for linear or branched, saturated or unsaturated, aliphatic or aromatic hydrocarbon groups with 1 to 30 carbon atoms, preferably 4 to 20 carbon atoms, further comprises a linear or branched, saturated or unsaturated, aliphatic or aromatic hydrocarbon group R² with 1 to 30 carbon atoms, preferably 2 to 22 carbon atoms that is neighboring a monohydroxylated intermediate group —CH₂CH(OH)— and in which x stands for values between 40 and 80, preferably between 40 and 60.

The suitable end capped polyoxyalkylated nonionic surfactants of the previous formula can be obtained, for example, by treating a terminal epoxide of the formula R²CH(O)CH₂ with an ethoxylated alcohol of the formula R¹O[CH₂CH₂O]ₓ₋₁CH₂CH₂OH.

Further particularly preferred end capped polyoxyalkylated nonionic surfactants are those of the formula
R¹O[CH₂CH₂O]ₓ[CH₂CH(CH₃)O]_{y}CH₂CH(OH)R²
in which R¹ and R² independently of one another stand for linear or branched, saturated or mono- or polyunsaturated hydrocarbon groups with 2 to 26 carbon atoms, R³ independently of each other is selected from —CH₃, —CH₂CH₃, —CH₂CH₂—CH₃, CH(CH₃)₂, preferably —CH₃, however, and x and y independently of one another stand for values between 1 and 32, wherein surfactants with values for x from 15 to 32 and y from 0.5 and 1.5 are quite particularly preferred.

Surfactants of the general formula 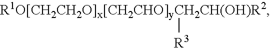
in which R¹ and R² independently of one another stand for linear or branched, saturated or mono- or polyunsaturated hydrocarbon groups with 2 to 26 carbon atoms, R³ independently of each other is selected from —CH₃, —CH₂CH₃, —CH₂CH₂—CH₃, CH(CH₃)₂, preferably —CH₃, however, and x and y independently of one another stand for values between 1 and 32, are inventively preferred, wherein nonionic surfactants with values for x from 15 to 32 and y from 0.5 and 1.5 are quite particularly preferred.

The cited carbon chain lengths and degrees of ethoxylation or alkoxylation of the above-mentioned nonionic surfactants constitute statistically average values that can be a whole or a fractional number for a specific product. Due to the manufacturing process, commercial products of the cited formulas do not consist in the main of one sole representative, but rather are a mixture, wherein not only the carbon chain lengths but also the degrees of ethoxylation or alkoxylation can be average values and thus be fractional numbers.

Of course, the above-mentioned nonionic surfactants can not only be employed as single substances, but also as surfactant mixtures of two, three, four or more surfactants. Accordingly, surfactant mixtures do not refer to mixtures of nonionic surfactants that as a whole fall under one of the above cited general formulas, but rather refer to such mixtures that comprise two, three, four or more nonionic surfactants that can be described by the different above-mentioned general formulas.

Exemplary suitable anionic surfactants are those of the sulfonate and sulfate type. Suitable surfactants of the sulfonate type are, advantageously C₉₋₁₃-alkylbenzene sulfonates, olefin sulfonates, i.e. mixtures of alkene- and hydroxyalkane sulfonates, and disulfonates, as are obtained, for example, from C₁₂₋₁₈-monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g., the α-sulfonated methyl esters of hydrogenated coco-, palm nut- or tallow acids are likewise suitable.

Further suitable anionic surfactants are sulfated fatty acid esters of glycerine. They include the mono-, di- and triesters and also mixtures of them, such as those obtained by the esterification of a monoglycerin with 1 to 3 moles fatty acid or the transesterification of triglycerides with 0.3 to 2 moles glycerin. Preferred sulfated fatty acid esters of glycerol in this case are the sulfated products of saturated fatty acids with 6 to 22 carbon atoms, for example, caproic acid, caprylic acid, capric acid, myristic acid, lauric acid, palmitic acid, stearic acid or behenic acid.

Preferred alk(en)yl sulfates are the alkali and especially sodium salts of the sulfuric acid half-esters derived from the C₁₂-C₁₈ fatty alcohols, for example, from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petro-chemical basis and which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. 2,3 alkyl sulfates, which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example, 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in fairly small quantities in cleansing agents, for example, in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates contain C₈₋₁₈ fatty alcohol groups or mixtures of them. Especially preferred sulfosuccinates comprise a fatty alcohol group derived from ethoxylated fatty alcohols and may be considered as nonionic surfactants (see description below). Once again the especially preferred sulfosuccinates are those, whose fatty alcohol groups are derived from ethoxylated fatty alcohols with narrow range distribution. It is also possible to use alk(en)ylsuccinic acid with preferably 8 to 18 carbon atoms in the alk(en)yl chain, or salts thereof.

Soaps in particular, can be considered as further anionic surfactants. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants, including soaps may be in the form of their sodium, potassium or ammonium salts or as soluble salts of organic bases, such as mono-, di- or triethanolamine. Preferably, the anionic surfactants are in the form of their sodium or potassium salts, especially in the form of sodium salts.

When the anionic surfactants are components of dishwasher detergents, their content, based on the total weight of the agent, is advantageously less than 4% by weight, preferably less than 2% by weight and quite particularly preferably less than 1% by weight. Dishwasher detergents, which comprise no anionic surfactants, are particularly preferred.

Cationic and/or amphoteric surfactants can be added instead of, or in combination with the cited surfactants.

As the cationic active substances, cationic compounds of the formulas III, IV or V for example, can be incorporated: 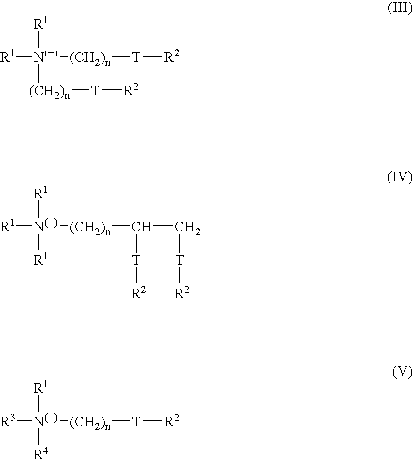
in which each group R¹, independently of one another, is chosen from C₁₋₆-alkyl, -alkenyl or -hydroxyalkyl groups; each group R², independently of one another, is chosen from C₈₋₂₈-alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

In dishwasher detergents, the content of cationic and/or amphoteric surfactants is advantageously less than 6% by weight, preferably less than 4% by weight, quite particularly preferably less than 2% by weight and in particular, less than 1% by weight. Dishwasher detergents, which comprise no cationic or amphoteric surfactants, are particularly preferred.

Polymers.

The group of polymers includes, in particular, the active detergent polymers or active cleansing polymers, for example, the rinsing polymers and/or polymers active for water softening. Generally, in addition to nonionic polymers, also cationic, anionic or amphoteric polymers are suitable for incorporation in detergents or cleansing agents.

In the context of the present invention, “cationic polymers” are polymers that carry a positive charge in the polymer molecule. These can be realized, for example, by (alkyl-) ammonium groups present in the polymer chain or other positively charged groups. Particularly preferred cationic polymers come from the groups of the quaternized cellulose derivatives, the polysiloxanes having quaternized groups, the cationic guar derivatives, the polymeric dimethyldiallylammonium salts and their copolymers with esters and amides of acrylic acid and methacrylic acid, the copolymers of vinyl pyrrolidone with quaternized derivatives of dialkylamino acrylate and -methacrylate, the vinyl pyrrolidone/methoimidazolinium chloride copolymers, the quaternized polyvinyl alcohols or the polymers listed under the INCI descriptions Polyquaternium 2, Polyquaternium 17, Polyquaternium 18 and Polyquaternium 27.

In the context of the present invention, “amphoteric polymers” are polymers that also possess, in addition to a positively charged group in the polymer chain, further negatively charged groups or monomer units. These groups can concern, for example, carboxylic acids, sulfonic acids or phosphonic acids.

Preferred detergents or cleansing agents, in particular, preferred dishwasher detergents are those that comprise a polymer a) that possesses monomer units of the formula R¹R²C═CR³R⁴, in which each group R¹, R², R³, R⁴ independently of each other is selected from hydrogen, derivatized hydroxyl groups, C₁ to C₃₀ linear or branched alkyl groups, aryl, aryl substituted C₁₋₃₀ linear or branched alkyl groups, polyalkoxylated alkyl groups, heteroatomic organic groups having at least one positive charge without charged nitrogen, at least one quaternized nitrogen atom or at least one amino group with a positive charge in the pH range 2 to 11, or salts hereof, with the proviso that at least one group R¹, R², R³, R⁴ is a heteroatomic organic group with at least one positive charge without charged nitrogen, at least one quaternized nitrogen atom or at least one amino group with a positive charge, and are particularly preferred in the context of the present application.

In the scope of the present application, particularly preferred cationic or amphoteric polymers comprise as the monomer unit a compound of the general formula 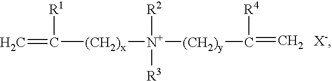
in which R¹ and R⁴ independently of one another stands for a linear or branched hydrocarbon group with 1 to 6 carbon atoms; R² and R³ independently of one another stand for an alkyl, hydroxyalkyl or aminoalkyl group, in which the alkyl group is linear or branched and has 1 to 6 carbon atoms, wherein it is preferably a methyl group; x and y independently of one another stand for whole numbers between 1 and 3. X⁻ represents a counter ion, preferably a counter ion from the group chloride, bromide, iodide, sulfate, hydrogen sulfate, methosulfate, lauryl sulfate, dodecylbenzene sulfonate, p-toluene sulfonate (tosylate), cumene sulfonate, xylene sulfonate, phosphate, citrate, formate, acetate or mixtures thereof.

Preferred groups R¹ and R⁴ in the above formula (VII) are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Quite particularly preferred polymers are those that possess a cationic monomer unit of the above general formula, in which R¹ and R⁴ stand for H, R² and R³ stand for methyl, and x and y are each 1. The monomer units corresponding to the formula
H₂C═CH—(CH₂)—N⁺(CH₃)₂—(CH₂)C H═CH₂X⁻
are also designated as DADMAC (diallyl dimethyl ammonium chloride) for the case where X=chloride.

Further particularly preferred cationic or amphoteric polymers comprise a monomer unit of the general formula
R¹HC═CR²—C(O)NH—(CH₂)ₓ—N⁺R³R⁴R⁵X³¹,
in which R¹, R², R³, R⁴ and R⁵ independently of one another stand for linear or branched, saturated or unsaturated alkyl, or hydroxyalkyl group with 1 to 6 carbon atoms, preferably for a linear or branched alkyl group selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x stands for a whole number between 1 and 6.

In the context of the present application, quite particularly preferred polymers possess a cationic monomer unit of the above general formula, in which R¹ stands for H, and R², R³, R⁴ and R⁵ stand for methyl, and x stands for 3.

The monomer units corresponding to the formula
H₂C═C(CH₃)—C(O)—NH—(CH₂)ₓ—N⁺(CH₃)₃X⁻
are also designated as MAPTAC (methylacrylamidopropyl-trimethyl ammonium chloride) for the case where X=chloride.

According to the invention, preferred polymers are used that comprise diallyl dimethyl ammonium salts and/or acrylamidopropyl trimethyl ammonium salts as monomer units.

The previously mentioned polymers possess not only cationic groups but also anionic groups or monomer units. These anionic monomer units come, for example, from the group of the linear or branched, saturated or unsaturated carboxylates, the linear or branched, saturated or unsaturated phosphonates, the linear or branched, saturated or unsaturated sulfates or the linear or branched, saturated or unsaturated sulfonates. Preferred monomer units are acrylic acid, the (meth)acrylic acids, the (dimethyl)acrylic acid, the (ethyl)acrylic acid, the cyanoacrylic acid, the vinylacetic acid, the allylacetic acid, the crotonic acid, the maleic acid, the fumaric acid, the cinnamic acid and its derivatives, the allylsulfonic acids, such as for example, allyloxybenzene sulfonic acid and methallyl sulfonic acid or the allylphosphonic acids.

Preferred usable amphoteric polymers come from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkyl methacrylate/alkylaminoethyl methacrylate/alkyl methacrylate copolymers as well as the copolymers of unsaturated carboxylic acids, cationic derivatized unsaturated carboxylic acids and optionally additional ionic or nonionic monomers.

Preferred usable zwitterionic polymers come from the group of the acrylamidoalkyl trialkyl ammonium chloride/acrylic acid copolymers as well as their alkali- and ammonium salts the acrylamidoalkyl trialkyl ammonium chloride/methacrylic acid copolymers as well as their alkali- and ammonium salts and their methacroylethylbetaine/methacrylate copolymers.

In addition, preferred amphoteric polymers are those that include methacrylamidoalkyl-trialkyl ammonium chloride and dimethyl(diallyl)ammonium chloride as the cationic monomer in addition to one or more anionic monomers.

Particularly preferred amphoteric polymers come from the group of methacrylamidoalkyl-trialkyl ammonium chloride/dimethyl(diallyl) ammonium chloride/acrylic acid copolymers, the methacrylamidoalkyl trialkyl ammonium chloride/dimethyl (diallyl) ammonium chloride/methacrylic acid copolymers and the methacrylamidoalkyl trialkyl ammonium chloride/dimethyl(diallyl)ammonium chloride/alkyl(meth)acrylic acid copolymers as well as their alkali metal and ammonium salts.

In particular, preferred amphoteric polymers are from the group of the methacrylamidopropyl trimethyl ammonium chloride/dimethyl(diallyl)ammonium chloride/acrylic acid copolymers, the methacrylamidopropyl trimethyl ammonium chloride/dimethyl(diallyl)ammonium chloride/acrylic acid copolymers and the methacrylamidopropyl trimethyl ammonium chloride/dimethyl(diallyl)ammonium chloride/alkyl(meth)acrylic acid copolymers as well as their alkali metal and ammonium salts.

In a particularly preferred embodiment of the present invention, the polymers are in preconditioned form. Suitable preconditioning of the polymers include

Encapsulation of the polymers by water-soluble or water-dispersible coating agents, preferably by water-soluble or water-dispersible natural or synthetic polymers;

Encapsulation of the polymers by water-insoluble, meltable coating agents, preferably by water-insoluble coating agents from the group of the waxes or paraffins having a melting point above 30° C.;

Cogranulation of the polymers with inert carriers, preferably with carriers from the group of detergent active or cleansing active substances, particularly preferably from the group of builders or cobuilders.

Detergents or cleansing agents comprise the above-mentioned cationic and/or amphoteric polymers in amounts between 0.01 and 10 wt. %, each based on the total weight of the detergent or cleansing agent. However, in the context of the present application, those detergents or cleansing agents are preferred, in which the weight content of the cationic and/or amphoteric polymers is between 0.01 and 8 wt. %, preferably between 0.01 and 6 wt. %, preferably between 0.01 and 4 wt. %, particularly preferably between 0.01 and 2 wt. % and especially between 0.01 and 1 wt. %, each based on the total weight of the automatic dishwasher detergent.

Exemplary polymers active for water softening are polymers with sulfonic acid groups, which are especially preferably employed.

Particularly preferred suitable polymers comprising sulfonic acid groups are copolymers of unsaturated carboxylic acids, monomers comprising sulfonic acid groups and optional further ionic or nonionogenic monomers.

In the context of the present invention, unsaturated carboxylic acids of the formula
R¹(R²)C═C(R³)COOH
are preferred monomers, in which R¹ to R³ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, wherein R⁴ is a saturated or unsaturated, linear or branched hydrocarbon group containing 1 to 12 carbon atoms.

Among the unsaturated carboxylic acids corresponding to the above formula, acrylic acid (R¹═R²═R³═H), methacrylic acid (R¹═R²═H; R³═CH₃) and/or maleic acid (R¹═COOH; R²═R³═H) are particularly preferred.

The preferred monomers containing sulfonic acid groups are those of the formula,
R⁵(R⁶)C═C(R⁷)—X—SO₃H
in which R⁵ to R⁷ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, wherein R⁴ is a saturated or unsaturated, linear or branched hydrocarbon group containing 1 to 12 carbon atoms, and X stands for an optionally present spacer group that is selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.
Preferred monomers are those of the formulas
H₂C═CH—X—SO₃H
H₂C═C(CH₃)—X—SO₃H
HO₃S—X—(R⁶)C═C(R⁷)—X—SO₃H
in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Accordingly, particularly preferred sulfonic acid-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamide, sulfomethylmethacrylamide and water-soluble salts of the cited acids.

Additional ionic or nonionogenic monomers are particularly ethylenically unsaturated compounds. Preferably, the content of these additional ionic or nonionogenic monomers in the added polymers is less than 20 wt. %, based on the polymer. Particularly preferred polymers for use consist solely of monomers of the formula R¹(R²)C═C(R³)COOH and monomers of formula R⁵(R⁶)C═C(R⁷)—X—SO₃H.

In summary, copolymers of

i) unsaturated carboxylic acids of the formula R¹(R²)C═C(R³)COOH,

in which R¹ to R³ independently of one another stands for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon group containing 1 to 12 carbon atoms,

ii) monomers containing sulfonic acid groups corresponding to the formula
R⁵(R⁶)C═C(R⁷)—X—SO₃H
in which R⁵ to R⁷ independently of one another stands for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms and X stands for an optionally present spacer group, selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or nonionic monomers
are particularly preferred.

Further particularly preferred copolymers consist of

i) one or a plurality of unsaturated carboxylic acids from the group acrylic acid, methacrylic acid and/or maleic acid

ii) one or a plurality of monomers containing sulfonic acid groups of the formulas:
H₂C═CH—X—SO₃H
H₂C═C(CH₃)—X—SO₃H
HO₃S—X—(R⁶)C═C(R⁷)—X—SO₃H
in which R⁶ and R⁷ independently of one another are selected from —H, —CH₃, —CH₂CH₃—CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or nonionic monomers.

The copolymers can contain monomers from groups (i) and (ii) and optionally (iii) in varying amounts, wherein all representatives of group (i) can be combined with all representatives of group (ii) and all representatives of group (iii). Particularly preferred polymers have defined structural units, which are described below.

For example, copolymers are preferred, which comprise structural units of the formula
—[CH₂—CHCOOH]ₘ—[CH₂—CHC(O)—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, then another polymer results whose incorporation is likewise preferred. The appropriate copolymers comprise structural units of the formula
—[CH₂—C(CH₃)COOH]ₘ—[CH₂—CHC(O)—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O(CH₂)ₙ— with n=0 to 4, —O—(C₆H₄)—, —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Consequently, copolymers that comprise structural units of the formula
—[CH₂—CHCOOH]ₘ—[CH₂—C(CH₃)C(O)—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are likewise preferred as copolymers of structural units of the formula
—[CH₂—C(CH₃)COOH]ₘ—[CH₂—C(CH₃)C(O)—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)—.

Instead of acrylic acid and/or methacrylic acid or in addition to them, maleic acid can also be incorporated as the particularly preferred monomer from group i). In this way, one arrives at inventively preferred copolymers that comprise structural units of the formula
—[HOOCCH—CHCOOH]ₘ—[CH₂—CHC(O)—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—CH₂)ₙ— with n=0 to 4, —O—(C₆H₄)—, —NH—C(CH₃)₂— or —NH—CH(CH₂CH₃)— are preferred, and to inventively preferred copolymers that comprise structural units corresponding to the formula
—[HOOCCH—CHCOOH]ₘ—[CH₂—C(CH₃)C(O)O—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—CH₂)ₙ— with n=0 to 4, —O—(C₆H₄)—, —NH—C(CH₃)₂— or —NH—CH(CH₂CH₃)— are preferred.

In summary, copolymers are inventively preferred, which comprise structural units of the formulas
—[CH₂—CHCOOH]ₘ—[CH₂—CHC(O)—Y—SO₃H]ₚ—
—[CH₂—C(CH₃)COOH]ₘ—[CH₂—CHC(O)—Y—SO₃H]ₚ—
—[CH₂—CHCOOH]ₘ—[CH₂—C(CH₃)C(O)—Y—SO₃H]ₚ—
—[CH₂—C(CH₃)COOH]ₘ—[CH₂—C(CH₃)C(O)—Y—SO₃H]ₚ—
—[HOOCCH—CHCOOH]ₘ—[CH₂—CHC(O)—Y—SO₃H]ₚ—
—[HOOCCH—CHCOOH]ₘ—[CH₂—C(CH₃)C(O)O—Y—SO₃H]ₚ—
in which m and p each stand for a whole natural number between 1 and 2,000 and Y stands for a spacer group selected from substituted or unsubstituted aliphatic, aromatic or araliphatic hydrocarbon groups containing 1 to 24 carbon atoms, wherein spacer groups, in which Y represents —O—CH₂)ₙ— with n=0 to 4, —O—(C₆H₄)—, —NH—C(CH₃)₂— or —NH—CH(CH₂CH₃)— are preferred.

The sulfonic acid groups may be present in the polymers completely or partly in neutralized form, i.e. the acidic hydrogen atom of the sulfonic acid groups can be replaced by metal ions, preferably alkali metal ions and more particularly sodium ions, in some or all of the sulfonic acid groups. The addition of copolymers containing partly or fully neutralized sulfonic acid groups is preferred according to the invention.

The monomer distribution of the inventively preferred copolymers used ranges for copolymers that comprise only monomers defined in groups (i) and (ii) from preferably 5 to 95 wt. % (i) and (ii) respectively, particularly preferably 50 to 90 wt. % monomer from group (i) and 10 to 50 wt. % monomer from group (ii) respectively, based on the polymer.

Particularly preferred terpolymers are those that comprise 20 to 85 wt. % monomer from group (i), 10 to 60 wt. % monomer from group (ii) and 5 to 30 wt. % monomer from group (iii).

The molecular weight of the inventively preferred sulfo-copolymers used can be varied to adapt the properties of the polymer to the desired application requirement. Preferred detergents or cleansing agents are those wherein the molecular weights of the copolymers are 2,000 to 200,000 gmol⁻¹, preferably 4,000 to 25,000 gmol⁻¹ and especially 5,000 to 15,000 gmol−1.

Bleaching Agents.

The bleaching agents are a particularly preferred incorporated active detergent or cleansing substance. Among the compounds, which serve as bleaches and liberate H₂O₂ in water, sodium percarbonate, sodium perborate tetrahydrate and sodium perborate monohydrate are of particular importance. Examples of further bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioic acids.

Moreover, bleaching agents from the group of the organic bleaching agents can also be used. Typical organic bleaching agents are the diacyl peroxides, such as e.g., dibenzoyl peroxide. Further typical organic bleaching agents are the peroxy acids, wherein the alkylperoxy acids and the arylperoxy acids may be named as examples. Preferred representatives that can be added are (a) peroxybenzoic acid and ring-substituted derivatives thereof, such as alkyl peroxybenzoic acids, but also peroxy-α-naphthoic acid and magnesium monoperphthalate, (b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamido peroxycaproic acid, N-nonenylamido peradipic acid and N-nonenylamido persuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid).

Chlorine- or bromine-releasing substances can also be incorporated as bleaching agents. Suitable chlorine- or bromine-releasing materials include, for example, heterocyclic N-bromamides and N-chloramides, for example, trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

Particularly preferred inventive detergents or cleansing agents, particularly dishwasher detergents comprise 1 to 35 wt. %, preferably 2.5 to 30 wt. %, particularly preferably 3.5 to 20 wt. % and particularly 5 to 15 wt. % bleaching agent, preferably sodium percarbonate.

The active oxygen content of the detergents or cleansing agents, particularly dishwasher detergents, based on the total weight of the agent, preferably ranges between 0.4 and 10 wt. %, particularly preferably between 0.5 and 8 wt. % and particularly between 0.6 and 5 wt. %. Particularly preferred agents possess an active oxygen content above 0.3 wt. %, preferably above 0.7 wt. %, particularly preferably above 0.8 wt. % and particularly above 1.0 wt. %.

Bleach Activators.

The detergents or cleansing agents can comprise bleach activators in order to achieve an improved bleaching action on washing or cleaning at temperatures of 60° C. and below. Bleach activators, which can be used are compounds which, under perhydrolysis conditions, yield aliphatic peroxycarboxylic acids having preferably 1 to 10 carbon atoms, in particular, 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular, tetraacetyl ethylenediamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenol sulfonates, in particular, n-nonanoyl- or isononanoyloxybenzene sulfonate (n- or iso-NOBS), carboxylic acid anhydrides, in particular, phthalic anhydride, acylated polyhydric alcohols, in particular, triacetin, ethylene glycol diacetate and 2,5-diacetoxy-2,5-dihydrofuran.

In the context of the present application, further preferred added bleach activators are compounds from the group of cationic nitriles, particularly cationic nitriles of the formula 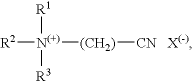
in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkyl or alkenylaryl group having a C₁₋₂₄ alkyl group or for a substituted alkyl or alkenylaryl group having a C₁₋₂₄ alkyl group and at least a further substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

A cationic nitrile of the formula 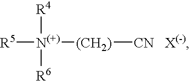
is particularly preferred, in which R⁴, R⁵ and R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵═R⁶═—CH₃ and in particular, R⁴═R⁵═R⁶═—CH₃ and compounds of the formulas (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preferred, wherein once again the cationic nitrile of the formula (CH₃)₃N⁽⁺⁾CH₂—CNX⁻, in which X⁻ stands for an anion selected from the group chloride, bromide, iodide, hydrogen sulfate, methosulfate, p-toluene sulfonate (tosylate) or xylene sulfonate.

Bleach activators, which can be used are compounds which, under perhydrolysis conditions, yield aliphatic peroxycarboxylic acids having preferably 1 to 10 carbon atoms, in particular, 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular, tetraacetyl ethylenediamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenol sulfonates, in particular, n-nonanoyl- or isononanoyloxybenzene sulfonate (n- or iso-NOBS), carboxylic acid anhydrides, in particular, phthalic anhydride, acylated polyhydric alcohols, in particular, triacetin, ethylene glycol diacetate and 2,5-diacetoxy-2,5-dihydrofuran, n-methyl-morpholinium-acetonitrile-ethyl sulfate (MMA) as well as acetylated sorbitol and mannitol or their mixtures (SORMAN), acylated sugar derivatives, in particular, pentaacetyl glucose (PAG), pentaacetyl fructose, tetraacetyl xylose and octaacetyl lactose as well as acetylated, optionally N-alkylated glucamine and gluconolactone, and/or N-acylated lactams, for example, N-benzoyl caprolactam. Hydrophillically substituted acyl acetals and acyl lactams are also preferably used. Combinations of conventional bleach activators may also be used.

In addition to, or instead of the conventional bleach activators mentioned above, so-called bleach catalysts may also be incorporated. These substances are bleach-boosting transition metal salts or transition metal complexes such as, for example, manganese-, iron-, cobalt-, ruthenium- or molybdenum-salen complexes or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts.

When additional bleach activators are intended to be used in addition to the nitrilequats, preferred bleach activators are added from the group of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or isononanoyl-oxybenzenesulfonate (n- or iso-NOBS), n-methyl morpholinium acetonitrile methyl sulfate (MMA), preferably in quantities of up to 10% by weight, more preferably in quantities of 0.1% by weight to 8% by weight, especially 2 to 8% by weight and especially preferably 2 to 6% by weight, based on the total weight of the bleach activator-containing agent.

Bleach-boosting transition metal complexes, more particularly containing the central atoms Mn, Fe, Co, Cu, Mo, V, Ti and/or Ru, preferably selected from the group of manganese and/or cobalt salts and/or complexes, particularly preferably the cobalt (ammine) complexes, cobalt (acetate) complexes, cobalt (carbonyl) complexes, chlorides of cobalt or manganese and manganese sulfate, are also used in typical quantities, preferably in a quantity of up to 5% by weight, especially in a quantity of 0.0025% by weight to 1% by weight and particularly preferably in a quantity of 0.01% by weight to 0.25% by weight, based on the total weight of the bleach activator-containing agent. In special cases, however, even more bleach activator may be used.

Enzymes.

Enzymes can be incorporated to increase the washing or cleansing performance of detergents or cleansing agents. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The detergents or cleansing agents preferably comprise enzymes in total quantities of 1×10⁻⁶ to 5 weight percent based on active protein. The protein concentration can be determined using known methods, for example, the BCA Process or the biuret process.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 and TW7. Subtilisin Carlsberg in further developed form is available under the trade name Alcalase® from Novozymes A/S, Bagsvæwrd, Denmark. Subtilisins 147 and 309 are commercialized under the trade names Esperase® and Savinase® by the Novozymes company. The variants sold under the name BLAP® are derived from the protease from Bacillus lentus DSM 5483.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect®) OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents and cleaning agents. The enzyme from B. licheniformis is available from the Novozymes Company under the name Termamyl® and from the Genencor Company under the name Purastar® ST. Further development products of this α-amylase are available from the Novozymes Company under the trade names Duramyl® and Termamyl® ultra, from the Genencor Company under the name Purastar® OxAm and from Daiwa Seiko Inc., Tokyo, Japan as Keistase®. The α-amylase from B. amyloliquefaciens is commercialized by the Novozymes Company under the name BAN®, and derived variants from the α-amylase from B. stearothermophilus under the names BSG® and Novamyl® also from the Novozymes Company.

Moreover, for these purposes, attention should be drawn to the α-amylase from Bacillus sp. A 7-7 (DSM 12368) and the cyclodextrin-glucanotransferase (CGTase) from B. agaradherens (DSM 9948).

Moreover, further developments of α-amylase from Aspergillus niger and A. oryzae available from the Company Novozymes under the trade name Fungamyl® are suitable. A further commercial product is the amylase-LT® for example.

According to the invention, lipases or cutinases can also be incorporated, particularly due to their triglyceride cleaving activities, but also in order to produce in situ peracids from suitable preliminary steps. These include the available or further developed lipases originating from Humicola lanuginosa (Thermomyces lanuginosus), particularly those with the amino acid substitution D96L. They are commercialized, for example, by the Novozymes Company under the trade names Lipolase®, Lipolase® Ultra, LipoPrime®, Lipozyme® and Lipex®. Moreover, suitable cutinases, for example, are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina and Fusarium solanii are for example, available from Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PL® as well as the product Lumafast® from Genencor Company.

In addition, enzymes, which are summarized under the term hemicellulases, can be added. These include, for example, mannanases, xanthanlyases, pectinlyases (=pectinases), pectinesterases, pectatlyases, xyloglucanases (=xylanases), pullulanases and β-glucanases. Suitable mannanases, for example, are available under the names Gamanase® and Pektinex AR® from Novozymes Company, under the names Rohapec® B1L from AB Enzymes and under the names Pyrolase® from Diversa Corp., San Diego, Calif., USA. β-Glucanase extracted from B. subtilis is available under the name Cereflo® from Novozymes Company.

To increase the bleaching action, oxidoreductases, for example, oxidases, oxygenases, katalases, peroxidases, like halo-, chloro-, bromo-, lignin-, glucose- or manganese-peroxidases, dioxygenases or laccases (phenoloxidases, polyphenoloxidases) can be incorporated according to the invention. Suitable commercial products are Denilite® 1 and 2 from the Novozymes Company. Advantageously, additional, preferably organic, particularly preferably aromatic compounds are added that interact with the enzymes to enhance the relative activity of the oxidoreductases or to facilitate the electron flow (mediators) between the oxidizing enzymes and the stains over strongly different redox potentials.

The enzymes either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

As an alternative application form, the enzymes can also be encapsulated, for example, by spray drying or extrusion of the enzyme solution together with a preferably natural polymer or in the form of capsules, for example, those in which the enzyme is embedded in a solidified gel, or in those of the core-shell type, in which an enzyme-containing core is covered with a water-, air- and/or chemical-impervious protective layer. Further active principles, for example, stabilizers, emulsifiers, pigments, bleaches or colorants can be applied in additional layers. Such capsules are made using known methods, for example, by vibratory granulation or roll compaction or by fluid bed processes. Advantageously, these types of granulates, for example, with an applied polymeric film former are dust-free and as a result of the coating are storage stable.

In addition, it is possible to formulate two or more enzymes together, so that a single granulate exhibits a plurality of enzymatic activities.

A protein and/or enzyme can be protected, particularly in storage, against deterioration such as, for example, inactivation, denaturation or decomposition, for example, through physical influences, oxidation or proteolytic cleavage. An inhibition of the proteolysis is particularly preferred during microbial preparation of proteins and/or enzymes, particularly when the compositions also contain proteases. For this use, detergents or cleansing agents can comprise stabilizers; the provision of these types of agents represents a preferred embodiment of the present invention.

One group of stabilizers are reversible protease inhibitors. For this, benzamidine hydrochloride, borax, boric acids, boronic acids or their salts or esters are frequently used, above all derivatives with aromatic groups, for example, ortho, meta or para substituted phenyl boronic acids or the salts or esters. Ovomucoid and leupeptin, inter alia, are mentioned as peptidic protease inhibitors; an additional option is the formation of fusion proteins from proteases and peptide inhibitors.

Further enzyme stabilizers are amino alcohols like mono-, di-, tri-ethanolamine and -propanolamine and their mixtures, aliphatic carboxylic acids up to C₁₂, such as, for example, succinic acid, other dicarboxylic acids or salts of the cited acids. End capped alkoxylated fatty acid amides are also suitable. Certain organic acids used as builders can additionally stabilize an included enzyme.

Lower aliphatic alcohols, but above all polyols such as, for example, glycerol, ethylene glycol, propylene glycol or sorbitol are further frequently used enzyme stabilizers. Likewise, calcium salts are used, such as for example, calcium acetate or calcium formate, and magnesium salts.

Polyamide oligomers or polymeric compounds like lignin, water-soluble vinyl copolymers or cellulose ethers, acrylic polymers and/or polyamides stabilize enzyme preparations against physical influences or pH variations. Polymers that contain polyamine-N-oxide are effective enzyme stabilizers. Other polymeric stabilizers are the linear C₈-C₁₈ polyoxyalkylenes. Alkyl polyglycosides can stabilize the enzymatic components of the inventive agents and even increase their performance. Crosslinked N-containing compounds also act as enzyme stabilizers.

Reducing agents and antioxidants increase the stability of enzymes against oxidative decomposition. A sulfur-containing reducing agent is sodium sulfite, for example.

The use of combinations of stabilizers is preferred, for example, of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is increased by the combination with boric acid and/or boric acid derivatives and polyols and still more by the additional effect of divalent cations, such as for example, calcium ions.

Preferably, one or a plurality of enzymes and/or enzyme preparations, preferably solid protease preparations and/or amylase preparations are incorporated in quantities from 0.1 to 5 wt. %, preferably from 0.2 to 4.5 wt. % and in particular, from 0.4 to 4 wt. %, each based on the total enzyme-containing agent.

Glass Corrosion Inhibitors.

Glass corrosion inhibitors prevent the occurrence of smears, streaks and scratches as well as iridescence on the glass surface of glasses washed in an automatic dishwasher. Preferred glass corrosion inhibitors come from the group of magnesium and/or zinc salts and/or magnesium and/or zinc complexes.

A preferred class of compounds that can be used to prevent glass corrosion are insoluble zinc salts.

In terms of the preferred embodiment, insoluble zinc salts are zinc salts with a solubility of maximum 10 grams zinc salt per liter of water at 20° C. According to the invention, examples of particularly preferred insoluble zinc salts are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The cited zinc compounds are preferably used in quantities that produce an amount of zinc ions in the agent between 0.02 and 10 wt. %, preferably between 0.1 and 5.0 wt. % and especially between 0.2 and 1.0 wt. %, based on the total agent containing the glass corrosion inhibitor. The exact content of the zinc salt or zinc salts in the agent naturally depends on the type of zinc salt—the lower the solubility of the added zinc salt, the higher must be its concentration in the agents.

As for the most part the insoluble zinc salts remain unchanged during the dishwasher process, the particle size of the salts is an important criteria for the salts not to stick to the glassware or machine parts. Agents are preferred in which the insoluble zinc salts have a particle size below 1.7 mm.

When the maximum particle size of the insoluble zinc salt lies below 1.7 mm, one need not worry about insoluble residues in the dishwasher. Preferably, in order to further minimise the danger of insoluble residues, the insoluble zinc salt has an average particle size that lies markedly below this value, for example, an average particle size of less than 250 μm. This is more and more true as the solubility of the zinc salt decreases. In addition, the efficiency of the glass corrosion inhibition increases with decreasing particle size. For zinc salts with very low solubility, the particle size preferably lies below 100 μm. For zinc salts with even lower solubility, it can be even less; for example, the average particle size for the very poorly soluble zinc oxide preferably lies below 100 μm.

A further preferred class of compounds are magnesium and/or zinc salt(s) of at least one monomeric and/or polymeric organic acid. These ensure that even on repeated use, the surfaces of the glassware are not corroded, especially that no smears, streaks and scratches or iridescence occur on the glass surfaces.

Although any magnesium and/or zinc salt(s) of monomeric and/or polymeric organic acids can be used, the magnesium and/or zinc salt(s) of monomeric and/or polymeric organic acids from the groups of the non-branched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxoacids, the amino acids and/or the polymeric carboxylic acids.

The spectrum of the inventive preferred zinc salts of organic acids, preferably organic carboxylic acids, ranges from salts that are difficultly soluble or insoluble in water, i.e. with a solubility below 100 mg/l, preferably below 10 mg/l, or especially are insoluble, to such salts with solubilities in water greater than 100 mg/l, preferably over 500 mg/l, particularly preferably over 1 g/l and especially over 5 g/l (all solubilities at a water temperature of 20° C.). The first group of zinc salts includes zinc citrate, zinc oleate and zinc stearate, the group of soluble zinc salts includes for example, zinc formate, zinc acetate, zinc lactate and zinc gluconate.

A particular advantageous glass corrosion inhibitor is a zinc salt of an organic carboxylic acid, particularly preferably a zinc salt from the group zinc stearate, zinc oleate, zinc gluconate, zinc acetate, zinc lactate and/or zinc citrate. Zinc ricinoleate, zinc abietate and zinc oxalate are also preferred.

In the context of the present invention, the content of zinc salt in the cleansing agent is advantageously between 0.1 and 5 wt. %, preferably between 0.2 and 4.0 wt. % and especially between 0.4 and 3 wt. %, and the content of zinc in the oxidized form (calculated as Zn²⁺) between 0.01 and 1 wt. %, preferably between 0.02 and 0.5 wt. % and especially between 0.04 and 0.2 wt. % respectively, based on the total weight of the agent containing the glass corrosion inhibitor.

Corrosion Inhibitors.

Corrosion inhibitors serve to protect the tableware or the machine, silver protection agents being particularly important in automatic dishwashing. Substances known from the prior art can be incorporated. Above all, silver protectors selected from the group of triazoles, benzotriazoles, bis-benzotriazoles, aminotriazoles, alkylaminotriazoles and the transition metal salts or complexes may generally be used. Benzotriazole and/or alkylaminotriazole are particularly preferably used. Exemplary inventively preferred suitable 3-amino-5-alkyl-1,2,4-triazoles can be cited: 5-, -propyl-, -butyl-, -pentyl-, -heptyl-, -octyl-, -nonyl-, -decyl-, -undecyl-, -dodecyl-, -isononyl-, -versatic-10-acidalkyl-, -phenyl-, -p-tolyl-, -(4-tert. butylphenyl)-, -(4-methoxyphenyl)-, -(2-, -3-, -4-pyridyl)-, -(2-thienyl)-, -(5-methyl-2-furyl)-, -(5-oxo-2-pyrrolidinyl)-, -3-amino-1,2,4-triazole. In dishwasher detergents, the alkylamino-1,2,4-triazoles or their physiologically compatible salts are used in a concentration of 0.001 to 10 wt. %, preferably 0.0025 to 2 wt. %, particularly preferably 0.01 to 0.04 wt. %. Preferred acids for the salt formation are hydrochloric acid, sulfuric acid, phosphoric acid, carbonic acid, sulfurous acid, organic carboxylic acids like acetic acid, glycolic acid, citric acid, succinic acid. Quite particularly active are 5-pentyl-, 5-heptyl-, 5-nonyl-, 5-undecyl-, 5-isononyl-, 5-versatic-10-acidalkyl-3-amino-1,2,4-triazoles as well as mixtures of these substances.

Frequently encountered in cleansing formulations, furthermore, are agents containing active chlorine, which may significantly reduce corrosion of the silver surface. In chlorine-free cleansing products, particular use is made of oxygen-containing and nitrogen-containing organic redox-active compounds, such as dihydric and trihydric phenols, e.g., hydroquinone, pyrocatechol, hydroxyhydroquinone, gallic acid, phloroglucinol, pyrogallol and derivatives of these classes of compound. Salts and complexes of inorganic compounds, such as salts of the metals Mn, Ti, Zr, Hf, V, Co and Ce are also frequently used. Preference is given in this context to the transition metal salts selected from the group consisting of manganese and/or cobalt salts and/or complexes, particularly preferably cobalt ammine complexes, cobalt acetato complexes, cobalt carbonyl complexes, the chlorides of cobalt or of manganese, and manganese sulfate. Zinc compounds may also be used to prevent corrosion of tableware.

Redox-active substances may be added instead of, or in addition to the above described silver protection agents, e.g., the benzotriazoles. These substances are preferably inorganic redox-active substances from the group of salts and/or complexes of manganese, titanium, zirconium, hafnium, vanadium, cobalt or cerium, in which the cited metals exist in the valence states II, III, IV, V or VI.

The metal salts or complexes used should be at least partially soluble in water. Suitable counterions for the salt formation include all usual mono, di or trivalent negatively charged inorganic anions, e.g., oxide, sulfate, nitrate, fluoride and also organic anions e.g., stearate.

In the context of the invention, metal complexes are compounds that consist of a central atom and one or several ligands as well as optionally one or several of the above-mentioned anions in addition. The central atom is one of the above-mentioned metals in one of the above-mentioned valence states. Ligands are neutral molecules or anions, which are monodentate or bidentate; in the context of the invention, the term “Ligands” is discussed in more detail in “Römpp Chemie Lexikon, Georg Thieme Verlag Stuttgart/New York, 9. Edition, 1990, page 2507”. If the charge on the central atom and the charge of the ligand(s) do not add up to zero, then according to whether a cationic or an anionic residual charge is present, either one or several of the above-mentioned anions or one or more of the cations e.g., sodium, potassium, ammonium ions equalise the charge difference. Suitable complex builders are e.g., citrate, acetylacetonate or 1-hydroxyethane-1,1-diphosphonate.

The current definition for “valence state” in chemistry is given in “Römpp Chemie Lexikon, Georg Thieme Verlag Stuttgart/New York, 9. Edition, 1991, page 3168.”

Particularly preferred metal salts and/or metal complexes are selected from the group MnSO₄, Mn(II)-citrate, Mn(II)-stearate, Mn(II)-acetylacetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ as well as their mixtures, such that preferred inventive automatic dishwasher agents are characterized in that the metal salts and/or metal complexes are selected from the group MnSO₄, Mn(II)-citrate, Mn(II)-stearate, Mn(II)-acetylacetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts and/or metal complexes are generally commercially available substances that can be employed in the detergents or cleansing agents for silver corrosion protection without prior cleaning. The mixture of pentavalent and tetravalent vanadium (V₂O₅, VO₂, V₂O₄), known from the SO₃ manufacturing process (Contact Process) is suitable, for example, similarly titanyl sulfate, TiOSO₄ that is formed by diluting a solution of Ti(SO₄)₂.

The inorganic redox-active substances, particularly metal salts or metal complexes are preferably coated, i.e. completely coated with a water-impermeable material that is easily soluble at the cleaning temperature, so as to prevent any premature decomposition or oxidation on storage. Preferred coating materials, which are applied using known processes, for instance hot melt coating process from Sandwik in the food industry, are paraffins, microwaxes, waxes of natural origin such as candelilla wax, carnuba wax, beeswax, higher-melting alcohols such as for example, hexadecanol, soaps or fatty acids. The coating material, which is solid at room temperature, is applied in the molten state onto the material to be coated, e.g., by projecting a continuous stream of finely-divided material to be coated through a likewise continuously produced atomized spray zone of molten coating material. The melting point must be chosen such that the coating material easily dissolves during the silver treatment and quickly solidifies. The melting point should ideally lie in the range 45° C. and 65° C. and preferably in the range 50° C. to 60° C.

The cited metal salts and/or metal complexes are comprised in the cleansing agents, preferably in a quantity of 0.05 to 6 wt. %, preferably 0.2 to 2.5 wt. %, each based on the total weight of the agent containing the corrosion inhibitor.

Disintegration Aids.

In order to facilitate the disintegration of the preconditioned molded bodies, disintegration aids, so-called tablet disintegrators, may be incorporated in the agents to shorten their disintegration times. According to Römpp (9th Edition, Vol. 6, page 4440) and Voigt “Lehrbuch der pharmazeutischen Technologie” (6th Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

The disintegration aids are preferably incorporated in quantities of 0.5 to 10 wt. %, advantageously from 3 to 7 wt. % and especially from 4 to 6 wt. %, each based on the total weight of the agent containing the disintegration aid.

Preferred disintegrators that are used are based on cellulose, and, therefore, the preferred detergent and cleansing agents comprise such a cellulose-based disintegrator in quantities from 0.5 to 10% by weight, advantageously 3 to 7% by weight and especially 4 to 6% by weight. Pure cellulose has the formal empirical composition (C₆H₁₀O₅)ₙ and, formally, is a β-1,4-polyacetal of cellobiose that, in turn, is made up of two molecules of glucose. Suitable celluloses consist of approximately 500 to 5,000 glucose units and, accordingly, have average molecular weights of 50,000 to 500,000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example, granulated or compacted. The particle sizes of such disintegrators are mostly above 200 μm, advantageously with 90 wt. % between 300 and 1600 μm and particularly at least 90 wt. % between 400 and 1200 μm. In the context of the present invention, the above-mentioned coarser disintegration aids, also described in greater detail in the cited publications, are preferred disintegration aids and are commercially available for example, from the Rettenmaier Company under the trade name Arbocel® TF-30-HG.

Microcrystalline cellulose can be used as a further cellulose-based disintegration aid, or as an ingredient of this component. The microcrystalline cellulose is obtained by the partial hydrolysis of cellulose, under conditions, which only attack and fully dissolve the amorphous regions (approximately 30% of the total cellulosic mass) of the cellulose, leaving the crystalline regions (approximately 70%) intact. Subsequent disaggregation of the microfine cellulose, obtained by hydrolysis, yields microcrystalline celluloses with primary particle sizes of approximately 5 μm and for example, compactable granules with an average particle size of 200 μm.

Preferred disintegration aids, advantageously a disintegration aid based on cellulose, preferably in granular, cogranulated or compacted form, are comprised in the disintegration aid-containing agent in quantities of 0.5 to 10 wt. %, preferably 3 to 7 wt. % and particularly 4 to 6 wt. %, each based on the total weight of the disintegration aid-containing agent.

Moreover, according to the invention, it can be preferred to incorporate additional effervescing systems as the tablet disintegration aids. The gas-evolving effervescent system can consist of a single substance, which liberates a gas on contact with water. Among these compounds, particular mention is made of magnesium peroxide, which liberates oxygen on contact with water. Normally, however, the gas-liberating effervescent system consists of at least two ingredients that react with one another to form gas. Although various possible systems could be used, for example, systems releasing nitrogen, oxygen or hydrogen, the effervescent system used in the detergent and cleansing agent should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

Among the alkali metal carbonates or hydrogen carbonates, the sodium and potassium salts are markedly preferred against the other salts for reasons of cost. Naturally, the relevant pure alkali metal carbonates or hydrogen carbonates need not be used; in fact, mixtures of different carbonates and hydrogen carbonates can be preferred.

In preferred effervescent systems, 2 to 20% by weight, advantageously 3 to 15% by weight and particularly 5 to 10% by weight of an alkali metal carbonate or -hydrogen carbonate are used, and 1 to 15, advantageously 2 to 12 and preferably 3 to 10% by weight of an acidifying agent, each based on the total weight of the agent.

Suitable acidifiers, which liberate carbon dioxide from alkali salts in aqueous solution, are for example, boric acid and alkali metal hydrogen sulfates, alkali metal dihydrogen phosphates and other inorganic salts. Preferably, however, organic acidifiers are used, citric acid being the preferred acidifier. However, solid mono-, oligo- and polycarboxylic acids are also particularly suitable. Within this group, citric acid, tartaric acid, succinic acid, malonic acid, adipic acid, maleic acid, fumaric acid, oxalic acid and polyacrylic acid are again preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifying agent for the purposes of the present invention.

Preferred acidifiers in the effervescing system are from the group of organic di-, tri- and oligocarboxylic acids or their mixtures.

Fragrances.

In the context of the present invention, suitable perfume oils or fragrances include individual perfume compounds, for example, synthetic products of the ester, ether, aldehyde, ketone, alcohol and hydrocarbon type. Perfume compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, ∝-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive perfume note, are preferably used. Perfume oils such as these may also contain natural perfume mixtures obtainable from vegetal sources, for example, pine, citrus, jasmine, patchouli, rose or ylang-ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and laudanum oil and orange blossom oil, neroli oil, orange peel oil and sandalwood oil.

The general description of the employable perfumes (see above) generally illustrates the different substance classes of perfumes. The volatility of a perfume is crucial for its perceptibility, whereby in addition to the nature of the functional groups and the structure of the chemical compound, the molecular weight also plays an important role. Thus, the majority of perfumes have molecular weights up to 200 daltons, and molecular weights of 300 daltons and above are quite an exception. Due to the different volatilities of perfumes, the smell of a perfume or fragrance composed of a plurality of odoriferous substances changes during evaporation, the impressions of odor being subdivided into the “top note,” “middle note” or “body” and “end note” or “dry out.” As the perception of smell also depends to a large extent on the intensity of the odor, the top note of a perfume or fragrance consists not solely from highly volatile compounds, whereas the endnote consists to a large extent from less volatile, i.e. tenacious odoriferous substances. In the composition of perfumes, higher volatile odoriferous substances can be bound, for example, onto particular fixatives, whereby their rapid evaporation is impeded. In the following subdivision of perfumes into “more volatile” or “tenacious” perfumes, nothing is mentioned about the odor impression and further, whether the relevant perfume is perceived as the top note or body note.

Exemplary tenacious odoriferous substances that can be used in the context of the present invention are the ethereal oils such as angelica root oil, aniseed oil, arnica flowers oil, basil oil, bay oil, bergamot oil, champax blossom oil, silver fir oil, silver fir cone oil, elemi oil, eucalyptus oil, fennel oil, pine needle oil, galbanum oil, geranium oil, ginger grass oil, guaiacum wood oil, Indian wood oil, helichrysum oil, ho oil, ginger oil, iris oil, cajuput oil, sweet flag oil, camomile oil, camphor oil, Canoga oil, cardamom oil, cassia oil, Scotch fir oil, copaiba balsam oil, coriander oil, spearmint oil, caraway oil, cumin oil, lavender oil, lemon grass oil, limette oil, mandarin oil, melissa oil, amber seed oil, myrrh oil, clove oil, neroli oil, niaouli oil, olibanum oil, orange oil, origanum oil, Palma Rosa oil, patchouli oil, Peru balsam oil, petit grain oil, pepper oil, peppermint oil, pimento oil, pine oil, rose oil, rosemary oil, sandalwood oil, celery seed oil, lavender spike oil, Japanese anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, citrus oil and cypress oil. However, in the context of the present invention, the higher boiling or solid odoriferous substances of natural or synthetic origin can be used as tenacious odoriferous substances or mixtures thereof, namely fragrances. These compounds include the following compounds and their mixtures: ambrettolide, α-amyl cinnamaldehyde, anethol, anisaldehyde, anis alcohol, anisole, methyl anthranilate, acetophenone, benzyl acetone, benzaldehyde, ethyl benzoate, benzophenone, benzyl alcohol, benzyl acetate, benzyl benzoate, benzyl formate, benzyl valeriate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, methyl heptyne carboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl-n-amyl ketone, methyl anthranilic acid methyl ester, p-methyl acetophenone, methyl chavicol, p-methyl quinoline, methyl-β-naphthyl ketone, methyl-n-nonyl acetaldehyde, methyl-n-nonyl ketone, muscone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, β-phenyl ethyl alcohol, phenyl acetaldehyde dimethyl acetal, phenyl acetic acid, pulegone, safrol, isoamyl salicylate, methyl salicylate, hexyl salicylate, cyclohexyl salicylate, santalol, scatol, terpineol, thymine, thymol, γ-undecalactone, vanillin, veratrum aldehyde, cinnamaldehyde, cinnamyl alcohol, cinnamic acid, ethyl cinnamate, benzyl cinnamate. The readily volatile odoriferous substances particularly include the low boiling odoriferous substances of natural or synthetic origin that can be used alone or in mixtures. Exemplary readily volatile odoriferous substances are alkyl isothiocyanates (alkyl mustard oils), butanedione, limonene, linalool, linalyl acetate and linalyl propionate, menthol, menthone, methyl-n-heptenone, phellandrene, phenyl acetaldehyde, terpinyl acetate, citral, citronellal.

The fragrances may be directly incorporated, although it can also be of advantage to apply the fragrances on carriers that due to a slower fragrance release ensure a longer lasting fragrance. Suitable carrier materials are, for example, cyclodextrins, the cyclodextrin/perfume complexes optionally being coated with other auxiliaries.

Colorants.

Preferred colorants, which are not difficult for the person skilled in the art to choose, have a high storage stability, are not affected by the other ingredients of the agent or by light and do not have any pronounced substantivity for the substrates such as glass, ceramics or plastic dishes being treated with the colorant-containing agent, so as not to color them.

When choosing the colorant, care must be taken in the case of laundry detergents that the colorants do not exhibit too strong an affinity for textile surfaces, especially synthetic fibers, while for cleansing agents, too strong an affinity for glass, ceramics or plastic tableware must be avoided. At the same time, the different stabilities of colorants towards oxidation must also be borne in mind when choosing suitable colorants. In general, water-insoluble colorants are more stable to oxidation than are water-soluble colorants. The concentration of the colorant in the detergents or cleansing agents, is varied depending on the solubility and, hence, also on the propensity to oxidation. For highly soluble colorants, e.g., the above cited Basacid® Green or the Sandolan® Blue, also cited above, colorant concentrations are typically chosen in the range of several 10⁻² to 10⁻³ wt. %. For the less highly soluble, but due to their brilliance, particularly preferred pigment dyes, e.g., the above cited Pigmosol® dyes, their suitable concentration in detergents or cleansing agents, in contrast, is typically several 10⁻³ to 10⁻⁴ wt. %.

Dyes are preferred that can be oxidatively destroyed in the washing process, as well as mixtures thereof with suitable blue colorants, the “blue toners”. It has also proved advantageous to employ dyes that are soluble in water or in liquid organic substances at room temperature. Anionic nitroso dyes, for example, are suitable. A possible dye is Naphtholgrün, for example, (Color Index (CI) Part 1: Acid Green 1, Part 2: 10020), which is commercially available as Basacid® Grün from BASF, Ludwigshafen, together with its mixtures with suitable blue colorants. Additional dyes that can be employed are Pigmosol® Blau 6900 (CI 74160), Pigmosol® Grün 8730 (CI 74260), Basonyl® Rot 545 FL (CI 45170), Sandolan® Rhodamin EB400 (CI 45100), Basacid® Gelb 094 (CI 147005), Sicovit® Patentblau 85 E 131 (CI 42051), Acid Blue 183 (CAS 12217-22-0, CI Acidblue 183), Pigment Blue 15 (CI 74160), Supranol® Blau GLW (CAS 12219-32-8, CI Acidblue 221)), Nylosan® Gelb N-7GL SGR (CAS 61814-57-1, CI Acidyellow 218) and/or Sandolan® Blau (CI Acid Blue 182, CAS 12219-26-0).

In addition to the components described in detail above, the detergents and cleansing agents can comprise additional ingredients that further improve the application technological and/or esthetic properties of the agents. Preferred agents comprise one or a plurality of materials from the group of the electrolytes, pH-adjustors, fluorescent agents, hydrotropes, foam inhibitors, silicone oils, anti-redeposition agents, optical brighteners, graying inhibitors, shrink preventers, anti-creasing agents, color transfer inhibitors, antimicrobials, germicides, fungicides, antioxidants, antistats, ironing auxiliaries, water proofing and impregnation agents, swelling and antipilling agents, sequestrants and UV absorbers.

A large number of the most varied salts can be employed as the electrolytes from the group of the inorganic salts. Preferred cations are the alkali and alkali earth metals, preferred anions are the halides and sulfates. The addition of NaCl or MgCl₂ to the detergents or cleansing agents is preferred from the industrial manufacturing point of view.

The addition of pH adjustors can be considered for bringing the pH of the detergents or cleansing agents into the desired range. Any known acid or alkali can be added, in so far as their addition is not forbidden on technological or ecological grounds or grounds of protection of the consumer. The amount of these adjustors does not normally exceed 1 wt. % of the total formulation.

Soaps, oils, fats, paraffins or silicone oils, optionally deposited on carrier materials, are examples of the foam inhibitors. Inorganic salts, such as carbonates or sulfates, cellulose derivatives or silicates as well as their mixtures are examples of suitable carrier materials. In the context of the present application, preferred agents comprise paraffins, preferably unbranched paraffins (n-paraffins) and/or silicones, preferably linear polymeric silicones that have the structure (R₂SiO)ₓ and which are also called silicone oils. These silicone oils are usually clear, colorless, neutral, odorless, hydrophobic liquids with a molecular weight between 1,000-150,000, and viscosities between 10 and 1,000,000 mPas.

Suitable anti-redeposition agents, also referred to as soil repellents are, for example, nonionic cellulose ethers such as methyl cellulose and methyl hydroxypropyl cellulose with a content of methoxy groups of 15 to 30 wt. % and hydroxypropyl groups of 1 to 15 wt. %, each based on the nonionic cellulose ether, as well as polymers of phthalic acid and/or terephthalic acid or their derivatives known from the prior art, particularly polymers of ethylene terephthalates and/or polyethylene glycol terephthalates or anionically and/or nonionically modified derivatives thereof. From these, the sulfonated derivatives of the phthalic acid polymers and the terephthalic acid polymers are particularly preferred.

Optical brighteners “whiteners” can be added to detergents or cleansing agents in order to eliminate graying and yellowing of the treated textiles. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds originate for example, from the substance classes of 4,4′-diamino-2,2′-stilbenedisulfonic acids (flavonic acids), 4,4′-distyrylbiphenylene, methylumbelliferone, coumarine, dihydroquinolinones, 1,3-diarylpyrazolines, naphthoic acid imide, benzoxazole-, benzisoxazole- and benzimidazole-systems as well as heterocyclic substituted pyrene derivatives.

Graying inhibitors have the function of maintaining the dirt that was removed from the fibers suspended in the washing liquor, thereby preventing the dirt from resettling. Water-soluble colloids of mostly organic nature are suitable for this, for example, the water-soluble salts of polymeric carboxylic acids, glue, gelatins, salts of ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g., degraded starches, aldehyde starches etc. Polyvinyl pyrrolidone can also be used. Additional anti-graying inhibitors that can be used are cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof.

As fabric surfaces, particularly of rayon, spun rayon, cotton and their mixtures can wrinkle of their own accord because the individual fibers are sensitive to flection, bending, pressing and squeezing perpendicular to the fiber direction, the agents can comprise synthetic crease-protection agents. These include, for example, synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

Repellency and impregnation processes serve to furnish the textiles with substances that prevent soil deposition or facilitate their washability. Preferred repellency and impregnation agents are perfluorinated fatty acids also in the form of their aluminum or zirconium salts, organic silicates, silicones, polyacrylic acid esters with perfluorinated alcohols or polymerisable compounds coupled with perfluorinated acyl or sulfonyl groups. Antistats can also be comprised. The soil repellent finish with repellency and impregnation agents is often classified as an easy-care finish. The penetration of the impregnation agent in the form of solutions or emulsions of the appropriate active substances can be facilitated by the addition of wetting agents that lower the surface tension. A further application area for repellency and impregnation agents is the water-repellent finishing of textile goods, tents, awnings, leather etc., in which contrary to waterproofing, the fabric pores are not blocked, and the material, therefore, remains breathable (water-repellent finishing). The water-repellents, used for water-repellent finishing, coat textiles, leather, paper, wood etc. with a very thin layer of hydrophobic groups, such as long chain alkyl or siloxane groups. Suitable water-repellent agents are e.g., paraffins, waxes, metal soaps etc. with added aluminum- or zirconium salts, quaternary ammonium compounds with long chain alkyl groups, urea derivatives, fatty acid modified melamine resins, salts of chromium complexes, silicones, organo-tin compounds and glutardialdehyde as well as perfluorated compounds. The finished water-repellent materials do not feel greasy; nevertheless, water droplets form drops on them, just like on greased materials, without welting them. Thus, silicone-impregnated fabrics, for example, have a soft feel and are water and soil repellent; spots of ink, wine, fruit juices and the like are easier to remove.

Antimicrobial agents can be employed to combat microorganisms. Depending on the antimicrobial spectrum and the action mechanism, antimicrobial agents are classified as bacteriostatic agents and bactericides, fungistatic agents and fungicides, etc. Important representatives of these groups are, for example, benzalkonium chlorides, alkylaryl sulfonates, halophenols and phenol mercuric acetate, wherein these compounds can also be totally dispensed with.

The agents can comprise additional antioxidants in order to prevent undesirable changes caused by oxygen and other oxidative processes to the detergents and cleansing agents and/or the treated fabric surfaces. This class of compounds includes, for example, substituted phenols, hydroquinones, pyrocatechols and aromatic amines as well as organic sulfides, polysulfides, dithiocarbamates, phosphites and phosphonates.

An increased wear comfort can result from the additional use of antistats. Antistats increase the surface conductivity and thereby allow an improved discharge of built-up charges. Generally, external antistats are substances with at least one hydrophilic molecule ligand and provide a more or less hygroscopic film on the surfaces. These mainly interface-active antistats can be subdivided into nitrogen-containing (amines, amides, quaternary ammonium compounds), phosphorus-containing (phosphoric acid esters) and sulfur-containing (alkyl sulfonates, alkyl sulfates) antistats. Lauryl (or stearyl) dimethyl benzyl ammonium chlorides are also suitable antistats for textiles or as additives to detergents, resulting in an additional finishing effect.

Rinse aids can also be employed for fabric care and to improve the fabric properties such as a softer feel and lower electrostatic charging (increased wear comfort). The active principles in rinse aid formulations are “esterquats,” quaternary ammonium compounds containing two hydrophobic groups, such as, for example, distearyl dimethyl ammonium chloride that, however, due to its inadequate biodegradability is increasingly replaced by quaternary ammonium compounds that comprise ester groups in their hydrophobic groups as target break points for the biological degradation.

These types of “esterquats” with improved biodegradability can be obtained for example, by the esterification of fatty acids with mixtures of methyldiethanolamine and/or triethanolamine and subsequent quaternization of the reaction products with alkylation agents by known methods. Dimethylol ethylene urea is also suitable as a finishing.

Silicone derivatives, for example, can be added to improve the water-absorption capacity, the wettability of the treated textiles and to facilitate ironing of the treated textiles. They additionally improve the final rinse behavior of the detergents or cleansing agents by their foam-inhibiting properties. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then be aminofunctional or quaternized or possess Si—OH, Si—H and/or SiCl bonds. Further preferred silicones are the polyalkylene oxide-modified polysiloxanes, i.e. polysiloxanes that for example, possess polyethylene glycols, as well as the polyalkylene oxide-modified dimethylpolysiloxanes.

Finally, according to the invention, UV absorbers can also be employed, which are absorbed on the treated textiles and improve the light stability of the fibers. Compounds, which possess these desired properties, are for example, the efficient radiationless deactivating compounds and derivatives of benzophenone having substituents in position(s) 2- and/or 4. Also suitable are substituted benzotriazoles, acrylates that are phenyl-substituted in position 3 (cinnamic acid derivatives), optionally with cyano groups in position 2, salicylates, organic Ni complexes, as well as natural substances such as umbelliferone and the endogenous urocanic acid.

In the context of the invention, protein hydrolyzates, due to their fiber-care action, are further preferred active substances from the field of detergents and cleansing agents. Protein hydrolyzates are product mixtures obtained by acid-, base- or enzyme-catalyzed degradation of proteins (albumins). According to the invention, the added protein hydrolyzates can be of both vegetal as well as of animal origin. Animal protein hydrolyzates are, for example, elastin, collagen, keratin, milk protein, and silk protein hydrolyzates, which can also be present in the form of their salts. According to the invention, it is preferred to use protein hydrolyzates of vegetal origin, e.g., soya, almond, rice, pea, potato and wheat protein hydrolyzates. Although it is preferred to add the protein hydrolyzates as such, optionally other mixtures containing amino acid or individual amino acids can also be added in their place, such as arginine, lysine, histidine or pyroglutamic acid. Likewise, it is possible to add derivatives of protein hydrolyzates, e.g., in the form of their fatty acid condensation products.

The non-aqueous solvents that according to the invention can also be added particularly include the organic solvents, of which only the most important can be mentioned here: Alcohols (methanol, ethanol, propanols, butanols, octanols, cyclohexanol), glycols (ethylene glycol, diethylene glycol), ethers and glycol ethers (diethyl ether, dibutyl ether, anisol, dioxane, tetrahydrofuran, mono-, di-, tri-, polyethylene glycol ethers), ketones (acetone, butanone, cyclohexanone), esters (acetates, glycol esters), amides and other nitrogen compounds (dimethyl formamide, pyridine, N-methylpyrrolidone, acetonitrile), sulfur-compounds (carbon sulfides, dimethyl sulfoxide, sulfolane), nitro-compounds (nitrobenzene), halogenated hydrocarbons (dichloromethane, chloroform, tetrachloromethane, tri-, tetrachloroethene, 1,2-dichloroethane, chlorofluorohydrocarbons), hydrocarbons (benzines, petroleum ether, cyclohexane, methylcyclohexane, decalin, terpene-solvents, benzene, toluene, xylenes). Alternatively, instead of the pure solvent, their mixtures can also be added, which for example, advantageously combine the solvent properties of different solvents. In the context of the present application, a particularly preferred solvent mixture of this type is for example, commercial cleaning benzine, a suitable mixture of different hydrocarbons for dry-cleaning, preferably with a content of C12 to C14 hydrocarbons of more than 60 wt. %, particularly preferably above 80 wt. % and especially above 90 wt. %, each based on the total weight of the mixture, preferably with a boiling range of 81 to 110° C.

1. A process for manufacturing a water-soluble or water-dispersible receptacle having at least one receiving chamber comprising the steps of:
(a) heating a first water-soluble or water-dispersible wrapping material to a temperature T¹;
(b) deforming the wrapping material to form a receiving chamber;
(c) cooling the shaped wrapping material to a temperature T² which is less than T¹; and
(d) deforming the wrapping material by enlarging the receiving chamber formed in step (b).

2. The process according to claim 1, wherein the water-soluble or water-dispersible wrapping material is heated in step (a) by hot air, by radiated heat or by contact with a hot plate.

3. The process according to claim 1, wherein the temperature T¹ is at least 35° C.

4. The process according to claim 1, wherein the cooling of the wrapping material in step (c) is realized by means of cold air or by contact with a cooled surface.

5. The process according to claim 1, wherein the temperature T² is at least 5° C. below the temperature T¹.

6. The process according to claim 1, wherein the volume of the receiving chamber in step (b) is at least 1 ml.

7. The process according to claim 1, wherein the ratio of the receiving chamber volume produced in step (d) to the receiving chamber volume produced in step (b) is 10:1 to 1:10.

8. The process according to claim 1, wherein one of the water-soluble or water-dispersible wrapping materials comprises a water-soluble or water-dispersible polymer.

9. The process according to claim 1, wherein the wrapping material is deformed in step (b) and/or step (d) by deep drawing.

10. The process according to claim 1, wherein the receiving chamber formed in step (b) is filled before or at the same time as cooling step (c).

11. The process according to claim 1, wherein the receiving chamber formed in step (b) is filled after cooling step (c).

12. The process according to claim 1, wherein the filled receiving chamber formed in step (d) is filled in a subsequent step (e).

13. The process according to claim 12, wherein the filled receiving chamber is sealed.

14. A process for manufacturing a water-soluble or water-dispersible receptacle having at least one receiving chamber comprising the steps of:
(a) heating a first water-soluble or water-dispersible wrapping material to a temperature T¹;
(b) deforming the wrapping material to form a receiving chamber;
(c) cooling the shaped wrapping material to a temperature T¹ which is less than T¹;
(d) deforming the wrapping material by enlarging the receiving chamber formed in step (b); and
(e) filling the receiving chamber with an active substance comprising at least one pharmaceutical, cosmetic, feed stuff, plant protection agent, fertilizer, adhesive, food stuff, body care substance, detergent, cleansing agent and mixtures thereof.

15. The process according to claim 14, wherein the active substances are selected from the group consisting of detergent, cleansing agent and mixtures thereof.

16. The process according to claim 15, wherein the detergent and cleansing agent active substances are selected from the group consisting of builders, surfactants, polymers, bleaching agents, bleach activators, enzymes, glass corrosion inhibitors, corrosion inhibitors, disintegration auxiliaries, fragrances, perfume carriers and mixtures thereof.

17. The process for manufacturing a water-soluble or water-dispersible receptacle having at least one receiving chamber, comprising the steps of:
(a) heating a first water-soluble or water-dispersible exterior material to a temperature T¹;
(b) molding the wrapping material by the action of a punch or compressed air to form a receiving chamber;
(c) cooling the shaped wrapping material to a temperature T² less than T¹; and
(d) deforming the wrapping material by the action of a vacuum to enlarge the receiving chamber formed in step (b).

18. The process according to claim 17, wherein the wrapping material in step (b) is fitted into a deep draw mold, wherein the resulting receiving chamber does not completely fill up the deep draw mold.

19. The process according to claim 18, wherein the volume of the receiving chamber formed in step (b) is between 30 and 60 volume percent of the deep draw mold.

20. The process according to claim 19, further comprising the step of filling the receiving chamber with an active substance selected from the group consisting of detergent, cleansing agent and mixtures thereof.
